(19) United States
(12) Patent Application Publication
(10) Pub. No.: US 2006/0282855 A1
(43) Pub. Date: Dec. 14, 2006

(54) Multiple remote display system

(75) Inventor: Neal D. Margulis, Woodside, CA (US)

Correspondence Address: JAMES EPPA HITE, III, 2318 LOUIS ROAD, PALO ALTO, CA, 94303-3635, US

(73) Assignee: Digital Display Innovations, LLC

(21) Appl. No.: 11/139,149

(22) Filed: May 27, 2005

Related U.S. Application Data
(63) Continuation-in-part of application No. 11/122,457, filed on May 5, 2005.

(51) Int. Cl. H04N 5/445; G06F 3/00; G06F 13/00

(52) U.S. Cl. 725/43; 725/37; 725/42

(57) ABSTRACT

A multi-display system includes a host system that supports both graphics and video based frames for multiple remote displays, multiple users or a combination of the two. For each display and for each frame, a multi-display processor responsively manages each necessary aspect of the remote display frame. The necessary portions of the remote display frame are further processed, encoded and where necessary, transmitted over a network to the remote display for each user. In some embodiments, the host system manages a remote desktop protocol and can still transmit encoded video or encoded frame information where the encoded video may be generated within the host system or provided from an external program source. Embodiments integrate the multi-display processor with either the video decoder unit, graphics processing unit, network controller, main memory controller, or any combination thereof The encoding process is optimized for network traffic and attention is paid to assure that all users have low latency interactive capabilities.

This application is a Continuation-in-Part of U.S. application Ser. No. 11/122,457 which was filed on May 5, 2005.

### BACKGROUND SECTION

1. Field of Invention

The present invention relates generally to a multi-display system, and more particularly to a multi-display home system that supports a variety of content and display types.

2. Description of the Background Art

Efficiently implementing multi-display home systems is a significant goal of contemporary home system designers and manufacturers. In conventional home systems, a computer system, even when part of a network, has a single locally connected display. A television display typically has numerous consumer electronics (CE) devices such as a Cable or Satellite set top box, a DVD player and various other locally connected sources of content. The cable or satellite set top box may include a terrestrial antennae for local over-the-air broadcasts and may also include local storage for providing digital video recorder capabilities.

Industry has attempted to add networking capability to consumer electronics devices as well as to design various Digital Media Players (DMPs) specifically to play media content accessible over a computer network. Some of these CE devices have also included web browsers with various capabilities. Additionally, manufacturers have produced display devices capable of local connections to both computer systems and to consumer electronics devices. However, despite these efforts, the ability to share computer-based content onto CE displays has fallen well short of user expectations for cost of various devices and desired features, ease of installation, and ease of use. Similarly, efforts to share television and video content over a network designed for a computer system have also fallen short of user expectations.

Computer system capabilities have continued to increase with more memory, more CPU horsepower, larger hard drives and an extensive set of operating system features and software applications. Modern operating systems allow multiple users to share use of a computer system by providing login information for each user that is secure from the other users of the system. However, the typical computer system allows only one user at a time. Even in more recent configurations where a few users can simultaneously time-share one computer system, the displays for each user need to be locally connected to the host computer system. There exist products to support remote users for the business market, but they are expensive, complicated to set up and maintain, and not well suited for the home environment.

Effectively solving the issue of remote display systems is one of the key steps in supporting multi-display home systems. Multiple remote displays driven from a single host computer allow multiple users from the location they choose to share the resources of the single host computer, thus reducing cost.

Additionally, supporting television and audio/video content over the same multi-display home system is an important goal as some rooms will have only one display device. In a typical home environment, each child may wish to be in their room and be able to either use a computer or watch television content using a single display screen. When using the display device as a computer, users will want to interact with the display using a keyboard and mouse, and will probably be sitting close to the screen. When using the display device as a television, they may want to interact with the display using a remote control and may not be sitting as close to the screen.

However, achieving a high quality user experience for multiple remote displays is of substantially increased complexity, so computer systems and audio/video systems may require additional resources for effectively managing and controlling, and interactive operation of multiple displays to a single host system. There remains, therefore, a need for an effective implementation of enhanced multi-display processor systems.

### SUMMARY

The present invention provides an effective implementation of a multi-display system. In one embodiment, initially, a multi-display system sharing one host system provides one or more remote display systems with interactive graphics and video capabilities.

The general process is for the host system to manage frames that correspond to each remote display system and to manage the process of updating the remote display systems over a network connection. The host system also supports a variety of external program sources for audio and video content from a variety of possible sources which may be transmitted to the host system as either analog, digital or in an encoded video format. There are three main preferred embodiments discussed in detail, though many variations of these three are also explained.

In the first preferred embodiment, a host system utilizes a traditional graphics processor, standard video and graphics processing blocks and some combination of software to support multiple and possibly remote displays. The graphics processor is configured for a very large frame size or some combination of frame sizes that are managed to correspond to the remote display systems. The software includes an explicit tracking software layer that can track when the frame contents for each display, the surfaces or subframes that comprise each frame and potentially which precincts or blocks of each surface, are updated. The encoding process for the frames, processed surfaces or subframes, or precincts of blocks, can be performed by some combination of the CPU and one of the processing units of the graphics processor. For program sources that include streams of compressed video, assuming the compressed video is in a form that can be decoded by the intended remote display system, the CPU can send the native stream of compressed video to the remote display system through the network. In sending the native stream, the CPU may include the additional windowing, positioning and control information for the remote display system such that when the remote display system decodes the native stream, the decoded frames are displayed correctly.

In the second preferred embodiment, a host system utilizes a traditional graphics processor whose display output paths normally utilized for local display devices are constructively connected to a multi-display processor. Supporting a combination of local and remote displays is possible. For remote displays, the graphics processor is configured to output multiple frames over the display output path at the highest frame rate possible for the number of frames supported in any one instance. The multi-display processor, configured to recognize the frame configurations for each display, manages the display data at the frame, scan line, group of scan line, precinct, or block level to determine or implicitly track which remote displays need which subframe updates. The multi-display processor then encodes the appropriate subframes and prepares the data for transmission to the appropriate remote display system.

The third preferred embodiment (FIG. 7) integrates a graphics processor and a multi-display processor to achieve an optimized system configuration. This integration allows for enhanced management of the display frames within a shared RAM where the graphics processor has more specific knowledge for explicitly tracking and managing each frame for each remote display. Additionally, the sharing of RAM allows the multi-display processor to access the frame data directly to both manage the frame and subframe updates and to perform the data encoding based on efficient memory accesses. A system-on-chip implementation of this combined solution is described in detail.

In each embodiment, after the data is encoded, a network processor, or CPU working in conjunction with a simpler network controller, transmits the encoded data to a remote display system. Each remote display system decodes the data intended for its display, manages the frame updates, performs the processing necessary for the display screen, and manages other features such as masking packets lost in network transmission. When there are no new frame updates, the remote display controller refreshes the display screen using data from the prior frame.

For external program sources, the host system identifies the type of video program data stream and which remote display systems have requested the information. Depending on the type of video program data, the need for any intermediate processing, and the decode capabilities of the remote display systems that have requested the data, the host system will perform various processing steps. In one scenario where the remote display system is not capable of directly supporting the incoming encoded video stream, the host system can decode the video stream, combine it with graphics data if needed, and encode the processed video program data into a suitable display update stream that can be processed by the remote display system. In the case where the video program data can be natively processed by the target remote display system, the host system performs less processing and forwards the encoded video stream from the external program source data stream preferably along with additional information to the target remote display system.

The network controller of the host and remote systems, and other elements of the network subsystems may feed back network information from the various wired and wireless network connections to the host system CPU, frame management, and data encoding systems. The host system uses the network information to affect the various processing steps of producing display frame updates and can vary the frame rate and data encoding for different remote display systems based on the network feedback. Additionally, for network systems that include noisy transmission channels, the encoding step may be combined with forward error correction protection in order to prepare the transmit data for the characteristics of the transmission channel. The combination of these steps produces an optimal system for maintaining an optimal frame rate with low latency for each of the remote display systems.

Therefore, for at least the foregoing reasons, the present invention effectively implements a flexible multi-display system that utilizes various heterogeneous components to facilitate optimal system interoperability and functionality. The present invention thus effectively and efficiently implements an enhanced multi-display system.

### BRIEF DESCRIPTION OF THE DRAWINGS

FIG. 1 is a block diagram of a multi-display home system including a host system, external program sources, multiple networks, and multiple remote display systems;

FIG. 2 is a block diagram of a host system of a multi-display system in accordance with one embodiment of the invention;

FIG. 3 shows a remote display in accordance with one embodiment of the invention;

FIG. 4 represents a memory organization and the path through a dual display controller portion of a graphics and display controller in accordance with one embodiment of the invention;

FIG. 5 represents a memory and display organization for various display resolutions, in accordance with one embodiment of the invention;

FIG. 6 shows a multi-display processor for the head end system of FIG. 2 in accordance with one embodiment of the invention;

FIG. 7 is a block diagram of an exemplary graphics and video controller with an integrated multi-display support, in accordance with one embodiment of the invention;

FIG. 8 is a data flow chart illustrating how subband encoded frames of display data are processed in accordance with one embodiment of the invention;

FIG. 9 is a flowchart of steps in a method for performing multi-display windowing, selective encoding, and selective transmission, in accordance with one embodiment of the invention; and

FIG. 10 is a flowchart of steps in a method for performing a local decode and display procedure for a client, in accordance with one embodiment of the invention.

### DETAILED DESCRIPTION OF THE PREFERRED EMBODIMENT

The present invention relates to improvements in multi-display host systems. The generic principles herein may be applied to other embodiments, and various modifications to the preferred embodiment will be readily apparent to those skilled in the art. While the described embodiments relate to multi-display home systems, the same principles could be applied equally to a multi-display system for retail, industrial or office environments.

Attempts have been made to have networked DVD players, networked digital media adaptors, thin clients or Windows Media Center Extenders support remote computing or remote media. Whereas a personal computer is easily upgraded to support improvements in video CODECs, web browsing and other enhancements, more fixed-function clients are seldom able to keep pace with that type of innovation. The basic problem with past approaches is that they cannot receive inputs and convert them to data types and software that is running on the remote client. For example, a Windows Media Center Extender (WMCE) may support playback of video content encoded with Microsoft's VC1 CODEC. However, that same WMCE client could not play back content encoded with a new CODEC that was not included when the client was deployed. Similarly, a Digital Media Adaptor (DMA) may include a web browser, but if a web site supports a recently released enhanced version of an animation program, the browser on the DMA is unlikely to support the enhanced version. Without going to the extent of utilizing a stripped down computer as the client, no client is able to support the myriad of software that is available for the computer.

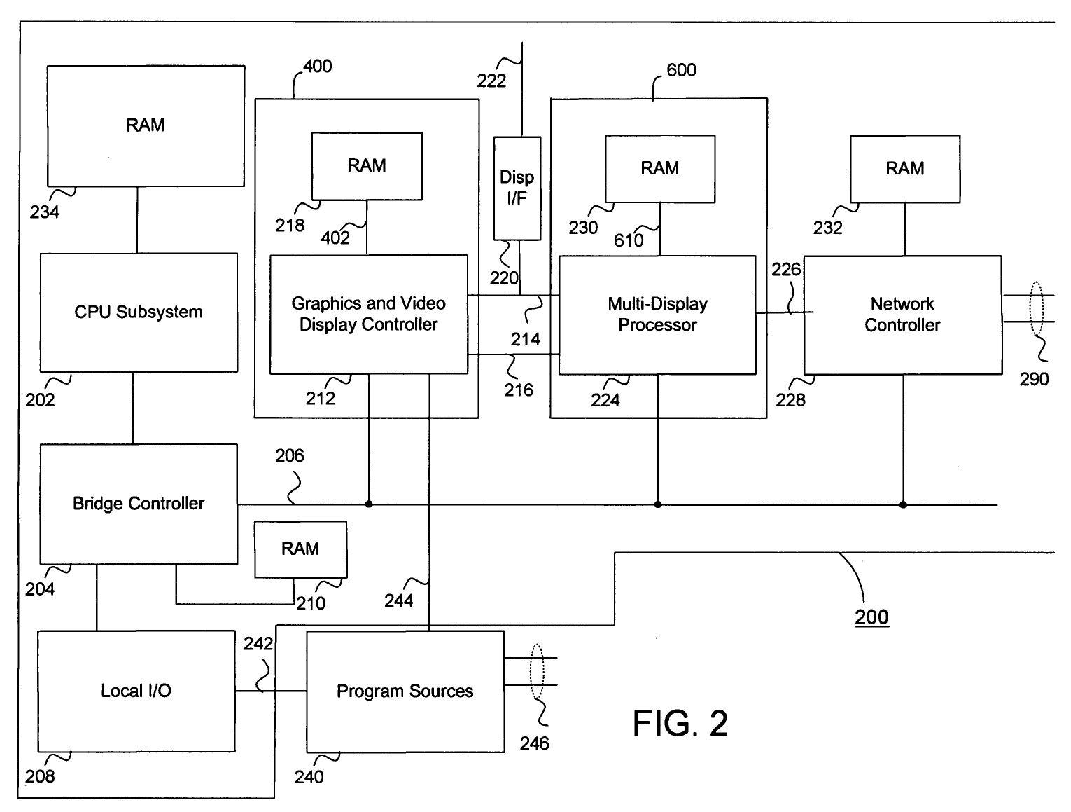

This system allows remote display devices to display content that could otherwise only be displayed on the host computer. The computer software and media content can be supported in three basic ways depending on the type of content and the capabilities of the remote display system. First, the software can be supported natively on the computer with the output display frames transmitted to the remote display system. Second, if there is media content that the remote display system can support in the original encoded video format, then the host system can provide the encoded video stream to the remote display system for decode remotely. Third, the content can be transcoded by the host system into an encoded data stream that the remote display system can decode. These three methods can be managed on a sub-frame or window basis so that combined, the system achieves the goals of compatibility and performance. The processes for transferring display updates and media streams from the host system 200 to a remote display system 300 are further discussed below in conjunction with FIGS. 2 through 10.

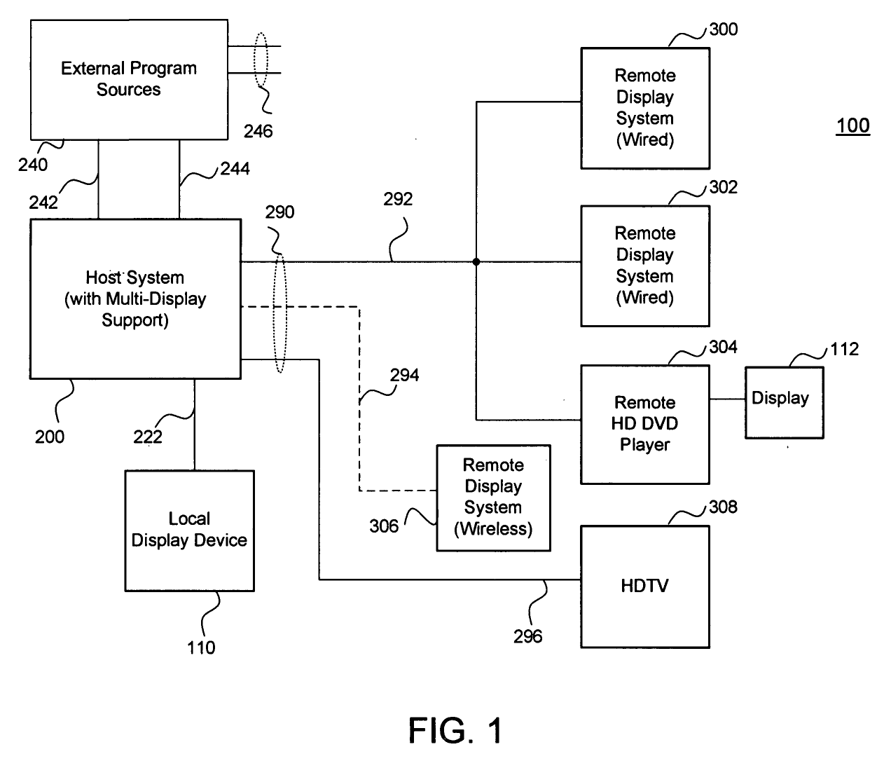

Referring to FIG. 1, the invention provides an efficient architecture for several embodiments of a multi-display system 100. A host system 200 processes multiple desktop and multimedia environments, typically one for each display, and, besides supporting local display 110, produces display update network streams for a variety of wired and wireless remote display systems. Wired displays can include remote display systems 300 and 302 that are able to decode one or more types of encoded data. Various consumer devices, such as a high definition DVD player 304 with an external display screen 112, high definition television (HDTV) 308, wireless remote display system 306, a video game machine (not shown) or a variety of Digital Media Adaptors (not shown) can be supported over a wired or wireless network. For a multi-user system, users at the remote locations are able to time-share the host system 200 as if it were their own local computer and have complete support for all types of graphics, text and video content with the same type of user experience that could be achieved on a local system.

Host system 200 also includes one or more input connections 242 and 244 with external program sources 240. The inputs may be digital inputs suitable for compressed video such as 1394 or USB, or for uncompressed video such as DVI or HDMI, or the inputs may include analog video such as S-Video, composite video or component video. There may also be audio inputs that are either separate from or shared with the video inputs. The program sources 240 may have various connections 246 to external devices such as satellite dishes for satellite TV, coaxial cable from cable systems, terrestrial antennae for broadcast TV, antenna for WiMAX connections or interfaces to fiber optics or DSL wiring. External program sources 240 can be managed by a CPU subsystem 202 (FIG. 2) with local I/O 208 connections 242 or by the graphics and video display controller 212 through path 244 (FIG. 2).

FIG. 2 is a block diagram illustrating first and second embodiments of the invention in the context of a host system 200 for a multi-display system 100. The basic components of host system 200 preferably include, but are not limited to, a CPU subsystem 202, a bus bridge-controller 204, a main system bus 206 such as PCI express, local I/O 208, main RAM 210, and a graphics and video display controller 212 having one or more dedicated output paths SDVO1 214 and SDVO2 216, and possibly its own memory 218. The graphics and video display controller 212 may have an interface 220 that allows for local connection 222 to a local display device 110.

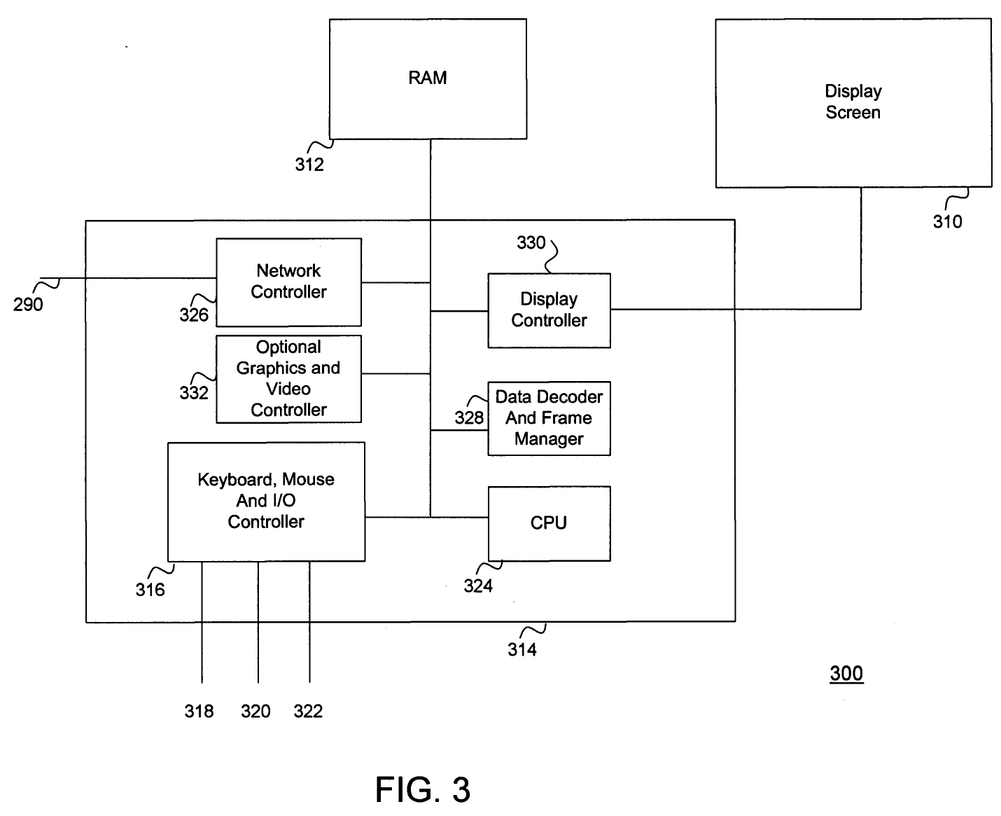

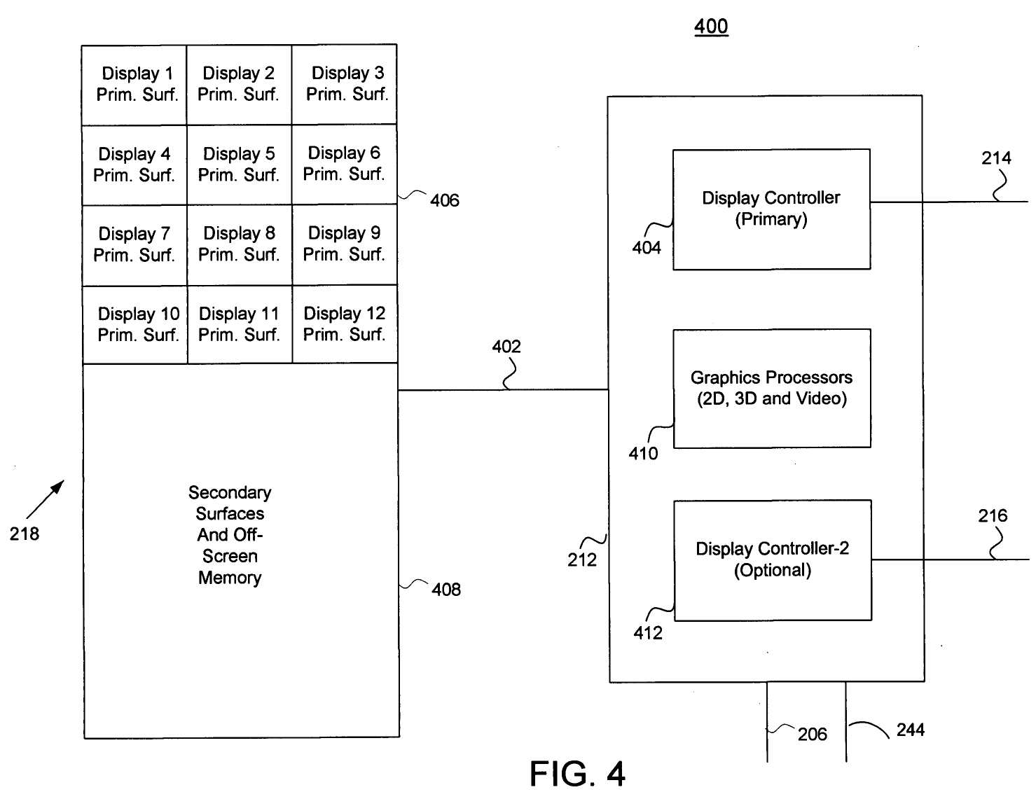

In a first preferred embodiment as illustrated by FIG. 2 without multi-display processor subsystem 600, a low cost combination of software running on the CPU subsystem 202, and on (FIG. 4) graphics and video processor (or GPU) 410 and standard display controller 404, supports a number of remote display systems 300 etc. (FIG. 3). This number of displays can be considerably in excess of what the display controller 404 can support locally via its output connections 214. The CPU subsystem 202 configures graphics memory 218 (or elsewhere) such that a primary surface of area 406 for each remote display 300 etc. is accessible at least by the CPU subsystem 202 and preferably also by the GPU 410. Operations that require secondary surfaces are performed in other areas of memory. Operations to secondary surfaces are followed by the appropriate transfers, either by the GPU or the CPU, into the primary surface area of the corresponding display. These transfers are necessary to keep the display controller 404 out of the path of generating new display frames.

Utilizing the CPU subsystem 202 and GPU 410 to generate a display-ready frame as a part of the primary surface allows relieving the display controller 404 from generating the display update stream for the remote display systems 300-306. Instead, the CPU 202 and GPU 410 can manage the contents of the primary surface frames and provide those frames as input to a data encoding step performed by the graphics and video processor 410 or the CPU subsystem 202. The graphics and video processor 410 may include dedicated function blocks to perform the encoding or may run the encoding on a programmable video processor or on a programmable GPU. The processing can preferably, by explicitly tracking which frames or sub frames are changed, process the necessary blocks of each primary surface to produce encoded data for the blocks of the frames that require updates. Those encoded data blocks are then provided to the network controller 228 for transmission to the remote display systems 300.

In a second preferred embodiment as further illustrated by FIG. 2, host system 200 also preferably includes a multi-display processor subsystem 600 that has both input paths SDVO1 214 and SDVO2 216 from the graphics and video display controller 212 and an output path 226 to network controller 228. Instead of dedicated path 226, multi-display processor subsystem 600 may be connected by the main system bus 206 to the network controller 228. The multi-display processor subsystem 600 may include a dedicated RAM 230 or may share main system RAM 210, graphics and video display controller RAM 218 or network controller RAM 232. Those familiar with contemporary computer systems will recognize that the main RAM 210 may be associated more closely with the CPU subsystem 202 as shown at RAM 234. Alternatively the RAM 218 associated with the graphics and video display controller 212 may be unnecessary as the host system 200 may share a main RAM 210. The function of multi-display processor 224 is to receive one or more display refresh streams over each of SDVO1 214 and SDVO2 216, manage the individual display outputs, process the individual display outputs, implicitly track which portions of each display change on a frame-by-fame basis, encode the changes for each display, format and process what changes are necessary and then provide a display update stream to the network controller 228.

Network controller 228 processes the display update stream and provides the network communication over one or more network connections 290 to the various display devices 300-306, etc. These network connections can be wired or wireless and may include multiple wired and multiple wireless connections. The implementation and functionality of a multi-display system 100 are further discussed below in conjunction with FIGS. 3 through 10.

FIG. 3 is a block diagram of a remote display system 300, in accordance with one embodiment of the invention, which preferably includes, but is not limited to, a display screen 310, a local RAM 312, and a remote display system controller 314. The remote display system controller 314 includes a keyboard, mouse and I/O controller 316 which has corresponding connections for a mouse 318, keyboard 320 and other miscellaneous devices 322 such as speakers for reproducing audio or a USB connection which can support a variety of devices. The connections can be dedicated single purpose such as a PS/2 style keyboard or mouse connection, or more general purpose such as a Universal Serial Bus (USB). In another embodiment, the I/O could include a game controller, a local wireless connection, an IR connection or no connection at all. Remote display system 300 may also include other peripheral devices such as a DVD drive. Configurations in which the remote display system 300 runs a Remote Display Protocol (RDP) or includes the ability to decode encoded video streams also include the optional graphics and video controller 332.

Some embodiments of the invention do not require any inputs at the remote display system 300. Examples of such embodiments are a retail store information sign, an airport electronic sign showing arrival gates, or an electronic billboard where different displays are available at different locations and can show variety of informative and entertaining information. Each display can be operated independently and can be updated based on a variety of factors. A similar system could also include some displays that accepts touch screen inputs as part of the display screen, such as an information kiosk.

In a preferred environment, the software that controls the I/O device is standard software that runs on the host computer and is not specific to the remote display system. The fact that the I/O connection to the host computer is supported over a network is made transparent to the device software by a driver on the host computer and by some embedded software running on the local CPU 324. Network controller 326 is also configured by local CPU 324 to support the transparent I/O control extensions.

The transparency of the I/O extensions can be managed according to the administrative preferences of the system manager. For example, one of the goals of the system may be to limit the ability of remote users to capture or store data from the host computer system. As such, it would not be desirable to allow certain types of devices to plug into a USB port at the remote display system 300. For example, a hard drive, a flash storage device, or any other type of removable storage would compromise data stored on the host system 200. Other methods, such as encrypting the data that is sent to the remote display system 300, can be used to manage which data and which user has access to which types of data.

In addition to the I/O extensions and security, the network controller 326 supports the protocols on the network path 290 where the supported networks could be wired or wireless. The networks supported for each remote display system 300 need to be supported by the FIG. 2 network controller 228 either directly or through some type of network bridging. A common network example is Ethernet, such as CAT 5 wiring running some type of Ethernet, preferably gigabit Ethernet, where the I/O control path may use an Ethernet supported protocol such as standard Transport Control Protocol and Internet Protocol (TCP/IP) or some form of lightweight handshaking in combination with UDP transmissions. Industry efforts such as Real-time Streaming Protocol (RTSP) and Real-Time Transfer Protocol (RTP) along with a Real-Time Control Protocol (RTCP) can be used to enhance packet transfers and can be further enhanced by adding re-transmit protocols. Other newer efforts around using Quality of Service (QoS) efforts such as layer 3 DiffServ Code Points (DSCP), the WMM protocol as part of Digital Living Network Alliance (DLNA), Microsoft Qwave, uPnP, QoS and 802. IP are also enhanced ways to use the existing network standards.

In addition to the packets for supporting the I/O devices, the network carries the encoded display data required for the display where the data decoder and frame manager 328 and the display controller 330 are used to support all types of visual data representations that may be rendered at the host system and to display them on display screen 310.

The display controller 330, data decoder and frame manager 328, and CPU 324 work together to manage a representation of the current image frame in the RAM 312 and to display the image on display 310. Typically, the image will be stored in RAM 312 in a format ready for display, but in systems where the cost of RAM is an issue, the image can be stored in the encoded format. When stored in an encoded format, in some systems, the external RAM 312 may be replaced by large buffers (not shown) within the remote display system controller 314. Some types of encoded data will be continuous bit streams of full frame rate video, such as an MPEG-4 program stream. The data decoder and frame manager 328 would decode and display the full frame rate video. If necessary, the display controller would scale the video to fit either the full screen or into a subframe window of the display screen. A more sophisticated display controller could also include a complete 2D, 3D and video processor for combining locally generated display operations with decoded display data.

After the display is first initialized, the host system 200 provides, over the network, a full frame of data for decode and display. Following that first frame of display data, the host system 200 need only send partial frame information over the network 290 as part of the display update network stream. If none of the pixels of a display are changed from the prior frame, the display controller 330 can refresh the display screen 310 with the prior frame contents from the local storage. When partial frame updates are sent in the display update network stream, the CPU 324 and the display data decoder 328 perform the necessary processing steps to decode the image data and update the appropriate area of RAM 312 with the new image. During the next refresh cycle, the display controller 330 will use this updated frame for display screen 310.

If the host system 200 is to transfer a data stream encoded in a form that the remote display system 300 can decode and display, then the host system may choose to transmit the data stream in the original encoded video format instead of decoding and re-encoding. For example, a remote display system utilizing an HDTV 308 may include an MPEG-2 decoder and limited graphics capability. If a data stream for that remote display system is an MPEG-2 stream, the host system 200 can transfer the native MPEG-2 stream over the available network connection 296 to the HDTV 308. The encoded video stream may be a stream that was stored locally within the host system 200, or a stream that is being received from one of the external program sources 240. The HDTV 308 may be configured to decode and display the data steam either as a full screen video, as a sub-frame video or as a video combined with graphics, where the HDTV 308 frame manager will manage the sub frame and graphics display. The network connection 296 used for an HDTV 308 may include multiplexing the multi-display data stream into the traditional channels found on the coaxial cable for a digital television system.

Other remote display systems 300 etc. can include one or more decoders for different formats of encoded video and encoded data. For example, a remote HD DVD player 304 may include decoding hardware for MPEG-2, MPEG-4, H.264 and VC1 such that the host system can transmit data streams in any of these formats in the original encoded format. 200A processed and encoded display update stream transmitted by the host system 200 must be in a format that the target remote display system 300 can decode. An HD DVD player 304 may also include substantial video processing and graphics processing hardware. The content from the host system 200 that is to be displayed by remote HD DVD player 304 can be translated and encoded into a format that utilizes the HD DVD standards for graphics and video. Additionally, the HD DVD player may include an API or have an operating system with a browser and its own middleware display architecture such that it can request and manage content transferred from the host system 200 or more directly from one of the external program sources 240. An advanced HD DVD player can be designed to support a Hybrid RDP remote display system as described below.

Hybrid RDP

There are products on the market that support a Microsoft Windows based set of functions called Remote Desktop Protocol (RDP) or another industry effort called X-Windows. RDP and X-Windows allow the graphics controller commands for 2D and 3D operations to be remotely performed by the optional graphics and video controller 332 in the remote system 300. Such a system has an advantage where the network bandwidth used can be very low as only a high level command needs to be transferred. However, the performance of the actual 2D and 3D operations becomes a function of the performance of the 2D and 3D graphics controller in the remote system, not the one in the host system. Additionally, a considerable amount of software is now required to run on the remote system 300 to manage the graphics controller, which in turn requires more memory and more CPU processing power in the remote system. Another limitation of the RDP and X-Windows protocols is that they do not support any optimal form of transmitted video.

Given the preceding limitations, one preferred embodiment of this invention adds video support to a remote display system, creating a hybrid system that is referred to here as a Hybrid RDP system, though it is just as applicable to a Hybrid X-Windows system.

A Hybrid RDP system can be used to support either remote computing via the RDP protocol or can use the enhanced methods of display frame update streams, encoded video streams, or a combination of the three.

Considering the case of a Hybrid RDP system and video playback, a software tracking layer on the host system will detect when a Hybrid RDP system wished to request a video stream. The RDP portion of the software protocol can treat the window that will contain the video as a single color graphics window. Transparently to the core RDP software, the tracking software layer will transmit the encoded video stream to the remote display system. The remote display system will have additional display driver software capable of supporting the decoding of the encoded video stream. The client display driver software may use the CPU 324, a graphics and video controller 332, the data decoder and frame manager 328, display controller 330 or some combination of these, to decode and output the display video stream into the display frame buffer. Additionally, display driver software will assure that the decoded video will be displayed on the correct portion of the display screen 310.

In another case, the Hybrid RDP system does not have sufficient capabilities to run a certain type of application. But as long as any application can run on a host system having frame update stream capabilities, the application can be supported by a Hybrid RDP system. Then the multi-display processor 224 performs the display encoding and produces a display frame update stream. The client display driver software may use the CPU 324, a video processor, the data decoder and frame manager 328, the display controller 330, or some combination to ensure that the Hybrid RDP system displays the requested information on the remote system display screen 310.

An enhanced version of the base RDP software can more readily incorporate the support for transmitting compressed video streams. The additional functions performed by the tracking software layer can also be performed by future versions of RDP software directly without the need for additional tracking software. As such, an improved version of an RDP based software product would be useful.

If the target remote display system, such as an HDTV 308, has support for only a single decoder (e.g., MPEG-2), then unless the host system can encode or transcode content into an MPEG-2 stream, content from host system 200 could not be displayed on the HDTV. While there is the possibility of supporting a variety of content using such an MPEG-2 decoder, it is not ideal as MPEG-2 can not readily be used to preserve sharp edges such as in a word processing document, and the latency from both the encode and decode processes may be longer than that of another CODEC. Still, it is a viable solution that allows supporting a greater amount of content than could otherwise be displayed. Having additional support for a low latency CODEC, such as a Wavelet transform based CODEC, for both the host system 200 and the remote display systems 300-308 is preferred. The processing for conversion and storage of the display update network stream is described in further detail with respect to FIGS. 4 through 10 below.

This second embodiment also uses what is conventionally associated with a single graphics and video display system 400 and a single SDVO connection to support multiple remote display systems 300-308. The method of multi-user and multi-display management is represented in FIG. 4 by RAM 218 data flowing through path 402 and the display controller 404 of the graphics and video display controller 212 to the output connections SDVO1 214 and SDVO2 216.

For illustration purposes, FIG. 4 organizes RAM 218 into various surfaces each containing display data for multiple displays. The primary surfaces 406, Display 1 through Display 12, are illustrated with a primary surface resolution that happens to match the display resolution for each display. This is for illustrative purposes though there is no requirement for the display resolution to be the same resolution as that of the primary surface. The other area 408 of RAM 218 is shown containing secondary surfaces for each display and supporting off-screen memory. The RAM 218 will typically be a common memory subsystem for graphics and video display controller 212, though the controller 212 may also share RAM with main system memory 210 or with the memory of another processor in system 100. In a shared memory system, contention may be reduced if there are available multiple concurrent memory channels for accessing the memory. The path 402 from RAM 218 to graphics and video display controller 212 may be time-shared.

The graphics and video display controller 212's 2D, 3D and video graphics processors 410 are preferably utilized to achieve high graphics and video performance. The graphics processor units may include 2D graphics, 3D graphics, video encoding, video decoding, scaling, video processing and other advanced pixel processing. The display controllers 404 and 412 may also include processing units for performing functions such as blending and keying of video and graphics data, as well as overall screen refresh operations. In addition to the RAM 218 used for the primary and secondary display surfaces, there is sufficient off-screen memory to support various 3D and video operations. Display controllers 404 and 412 may support multiple secondary surfaces. Multiple secondary surfaces are desirable as one of the video surfaces may need to be upscaled while another video surface may need to be downscaled.

When the host system 200 receives an encoded data stream from one of the external program sources 240, it may be necessary for the video decoder portion of graphics and video processor 410 to decode the video. The video decoding is typically performed into off-screen memory 408. The display controllers will typically combine the primary surface with one or more secondary surfaces to support the display output of a composite frame, though it is also possible for graphics and video processor 410 to perform the compositing into a single primary surface.

When host system 200 receives an encoded video stream from one of the external program sources 240, and the encoded video format matches the format available in the target remote display device, the host system can choose to transmit the encoded video stream as the original encoded video stream to the remote display system 300-308 without performing video decoding. If host system 200 does not perform the decoding then the display data within the encoded data stream can not be manipulated by the graphics and video controller 212. All operations such as scaling the video, overlay with graphics and other video processing tasks will therefore be performed by the remote video display.

In a single-display system, display controller 404 would be configured to access RAM 218, process the data and output a proper display resolution and configuration over output SDVO1 214 for the single display device. Preferably, display controller 404 is configured for a display size that is much larger than a single display to thereby accommodate multiple displays. Assuming the display controller 404 of a typical graphics and video display controller 212 was not specifically designed for a multi-display system, the display controller 404 can typically only be configured for one display output configuration at a time. It however may be practical to consider display control 404 to be configured to support an oversized single display as that is often a feature used by “pan and scan” display systems and may be just a function of setting the counters in the display control hardware.

In the illustration of FIG. 4, consider that each display primary surface represents a 1024×768 primary surface corresponding to a 1024×768 display. Stitching together six 1024×768 displays as tiles, three across and two down, would require display controller 212 to be configured to three times 1024, or 3072 pixels of width, by two times 768, or 1536 pixels of height. Such a configuration would accommodate Displays 1 through 6.

Display controller 404 would treat the six tiled displays as one large display and provide the scan line based output to SDVO1 output 214 to the multi-display processor 224. Where desired, display controller 404 would combine the primary and secondary surfaces for each of the six tiled displays as one large display. The displays labeled 7 through 12 could similarly be configured as one large display for Display Controller 2 412 through which they would be transferred over SDVO2 216 to the multi-display processor 224.

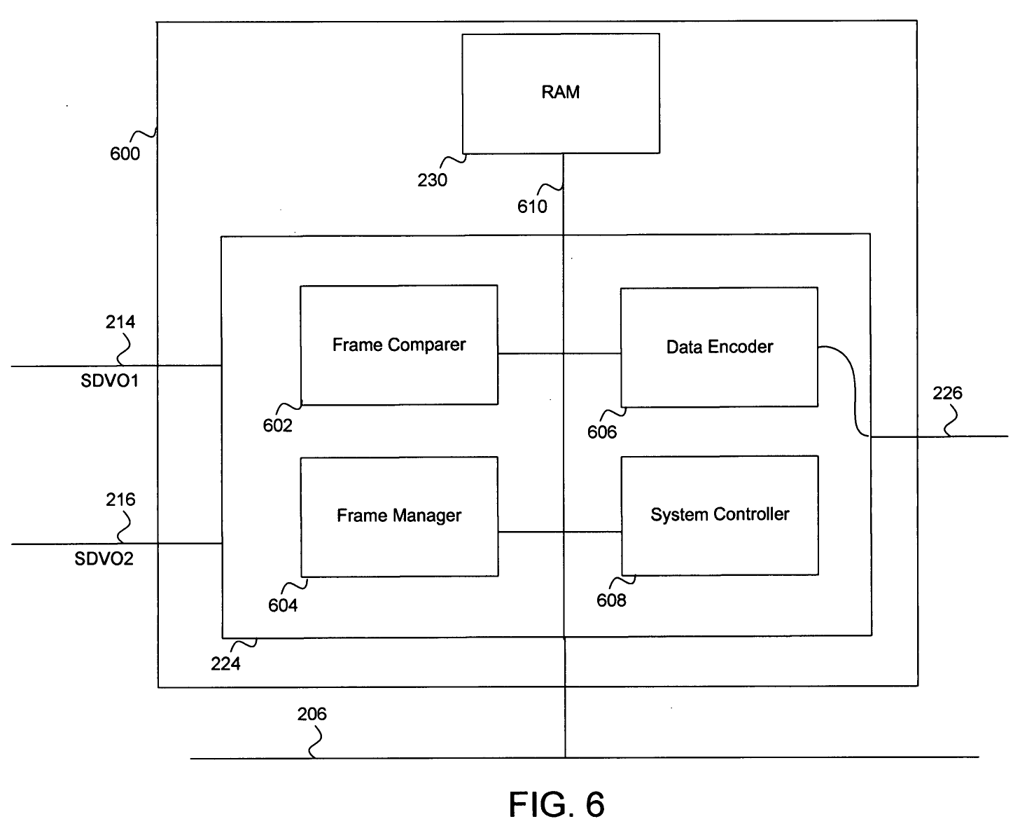

In a proper configuration, FIG. 6 multi-display processor 224 manages the six simultaneous displays properly and processes as necessary to demultiplex and capture the six simultaneous displays as they are received over SDVO1 214.

In FIG. 4 primary surface 406 the effective scan line is three times the minimum tiled display width, making on-the-fly scan line based processing considerably more expensive. In a preferred environment for on-the-fly scan line based processing, display controller 404 is configured to effectively stack the six displays vertically in one plane and treat the tiled display as a display of resolution 1024 pixels horizontally by six times 768, or 4608, pixels vertically. To the extent it is possible with the flexibility of the graphics subsystem, it is best to configure the tiled display in this vertical fashion to facilitate scan line based processing. Where it is not possible to configure such a vertical stacking, and instead a horizontal orientation needs to be included, it may be necessary to only support precinct based processing where on-the-fly encoding is not done. In order to minimize latency, when the minimum number of lines has been scanned, the precinct based processing can begin and effectively be pipelined with additional scan line inputs.

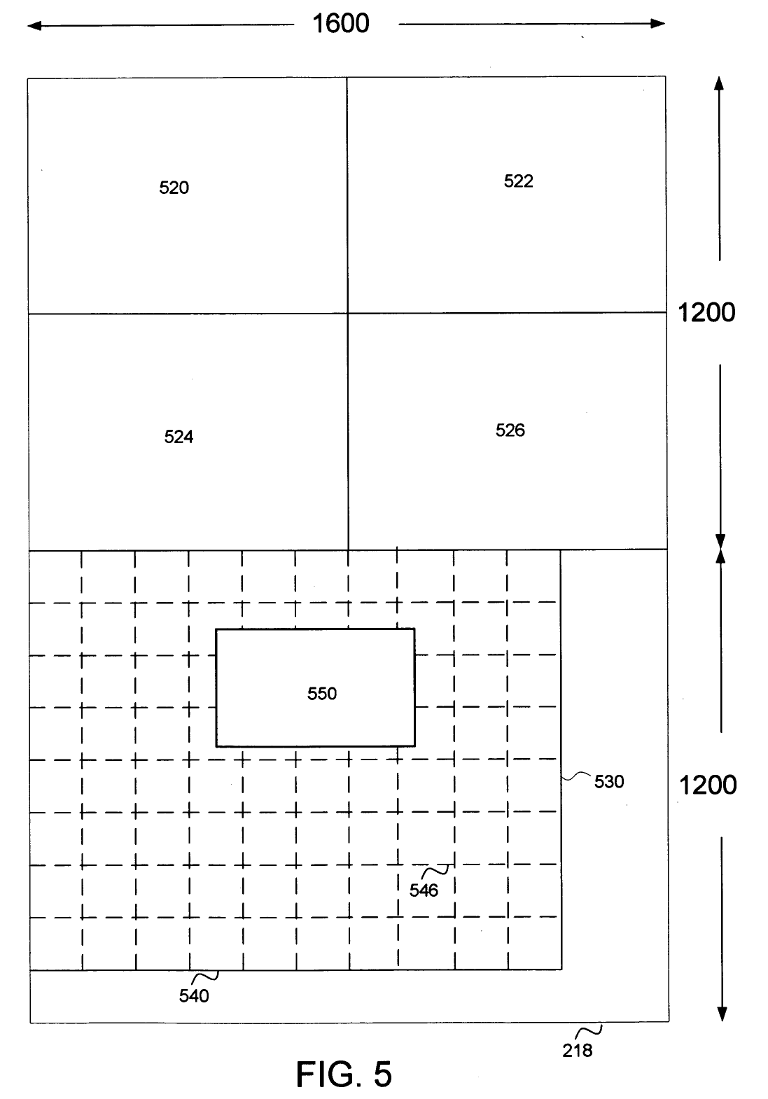

FIG. 5 shows a second configuration where the tiled display is set to 1600 pixels horizontally and two times 1200 pixels or 2400 pixels vertically. Such a configuration would be able to support two remote display systems 300 of resolution 1600×1200 or eight remote displays of 800×600 or a combination of one 1600×1200 and four 800×600 displays. FIG. 5 shows the top half of memory 218 divided into four 800×600 displays labeled 520, 522, 524 and 526.

Additionally, the lower 1600×1200 area could be sub-divided to an arbitrary display size smaller than 1600×1200. As delineated with rectangle sides 530 and 540, a resolution of 1280×1024 can be supported within a single 1600×1200 window size. Because the display controller 404 is treating the display map as a single display, the full rectangle of 1600×2400 would be output and it would be the function of the multi-display controller 224 to properly process a sub-window size for producing the display output stream for the remote display system(s) 300-306. A typical high quality display mode would be configured for a bit depth of 24 bits per pixel, though often the configuration may utilize 32 bits per pixel as organized in RAM 218 for easier alignment and potential use of the extra eight bits for other purposes when the display is accessed by the graphics and video processors.

FIG. 5 also illustrates the arbitrary placement of a display window 550 in the 1280×1024 display. The dashed lines 546 of the 1280×1024 display correspond to the precinct boundaries assuming 128×128 precincts. While in this example the precinct edges line up with the resolution of the display mode, such alignment is not necessary. As is apparent from display window 550 the alignment of the display window boundaries does not line up with the precinct boundaries. This is a typical situation as a user will arbitrarily size and position a window on a display screen. In order to support remote screen updates that do not require the entire frame to be updated, all of the precincts that are affected by the display window 550 need to be updated. Furthermore, the data type within the display window 550 and the surrounding display pixels may be of completely different types and not correlated. As such, the precinct based encoding algorithm, if it is lossy, needs to assure that there are no visual artifacts associated with either the edges of the precincts or with the borders of the display window 550. The actual encoding process may occur on blocks that are smaller, such as 16×16, than the precincts.

The illustration of the tiled memory is conceptual in nature as a view from the display controller 404 and display controller-2 412. The actual RAM addressing will also relate to the memory page sizes and other considerations. Also, as mentioned, the memory organization is not a single surface of memory, but multiple surfaces, typically including an RBG surface for graphics, one or more YUV surfaces for video, and an area of double buffered RGB surfaces for 3D. The display controller combines the appropriate information from each of the surfaces to composite a single image where any of the surfaces could first be processed by upscaling, downscaling or another operation. The compositing may also include alpha blending, transparency, color keying, overlay and other similar functions to combine the data from the different planes. In Microsoft Windows XP terminology, the display can be made up of a primary surface and any number of secondary surfaces. The FIG. 4 sections labeled Display 1 through Display 12 can be thought of as primary surfaces 406 whereas the secondary surfaces 408 are managed in the other areas of memory. Surfaces are also sometimes referred to as planes.

The 2D, 3D and video graphics processors 410 would control each of the six displays independently with each possibly utilizing a windowed user environment in response to the display requests from each remote display system 300. This could be done by having the graphics and video operations performed directly into the primary and secondary surfaces, where the display controller 404 composites the surfaces into a single image. Another example is to use the primary surfaces and to perform transfers from the secondary surfaces to the primary surfaces, while performing any necessary processing or combining of the surfaces along with the transfer. As long as the transfers are coordinated to occur at the right times, adverse display conditions associated with non-double buffered displays can be minimized. The operating system and driver software may allow for some of the more advanced operations for combining primary and secondary surfaces to not be supported by indicating to the software that such advanced functions, such as transparency, are not available functions. In other cases, the 3D processing hardware could be optimized to support sophisticated combining operations. Future operating systems, such as Microsoft Longhorn, utilize the 3D hardware pipeline for supporting traditional 2D graphics operations such that supporting effects such as transparency can be supported.

In a typical prior art system, a display controller 404 would be configured to produce a refresh rate corresponding to the refresh rate of a local display. A typical refresh rate may be between 60 and 85 Hz though possibly higher and is somewhat dependent on the type of display and the phosphor or response time of the physical display elements within the display. Because the graphics and video display controller 212 is split over a network from the actual display device 310, screen refreshing needs to be considered for this system partitioning.

Considering the practical limitations of the SDVO outputs from an electrical standpoint, a 1600×1200×24 configuration at 76 Hz is approximately a 3.5 Gigabits per second data rate. Increasing the tiled display to two times the height would effectively double the data and would require cutting the refresh rate in half to 38 Hz to still fit in a similar 3.5 Gigabits per second data rate. Because in this configuration the SDVO output is not directly driving the display device, the refresh requirements of the physical display elements of the display devices are of no concern. The refresh requirements can instead be met by the display controller 330 of the remote display controller 314.

Though not related to the refresh rate, the display output rate for the tiled display configuration is relevant to the maximum frame rate of new unique frames that can be supported and it is one of the factors contributing to the overall system latency. Since full motion is often considered to be 24 or 30 frames per second, the example configuration discussed here at 36 Hz could perform well with regard to frame rate. In general, the graphics and video drawing operations that write data into the frame buffer are not aware of the refresh rate at which the display controller is operating. Said another way, the refresh rate is software transparent to the graphics and video drawing operations.

For each display refresh stream output on SDVO1 214 the multi-display processor 224 also needs the stream management information as to which display is the target recipient of the update and where within the display (which precincts, for systems that are precinct-based) the new updated data is intended for, and includes the encoded data for the display. This stream management information can either be part of the stream output on SDVO1 214 or transmitted in the form of a control operation performed by the software management from the CPU subsystem 202.

In FIG. 5 window 550 does not align with the drawn precincts and may or may not align with blocks of a block-based encoding scheme. Some encoding schemes will allow arbitrary pixel boundaries for an encoding subframe. For example, if window 550 utilizes text and the encoding scheme utilized RLE encoding, the frame manager can set the sub-frame parameters for the window to be encoded to exactly the size of the window. When the encoded data is sent to the remote display system, it will also include both the window size and a window origin so that the data decoder and frame manager 328 can determine where to place the decoded data into decoded frame.

If the encoding system used does not allow for arbitrary pixel alignment, then the pixels that extend beyond the highest block size boundary either need to be handled with a pixel-based encoding scheme, or the sub-frame size can be extended beyond the window 550 size. The sub-frame size should only be extended if the block boundary will not be evident by separately compressing the blocks that extend beyond the window.

Assuming window 550 is generated by a secondary surface overlay, the software tracking layer can be useful for determining when changes are made to subsequent frames. Even though the location of the secondary surface is known, because of various overlay and keying possibilities, the data to be encoded should come from stage after the overlay and keying steps are performed by either one of the graphics engines or by the display processor.

FIG. 6 is a block diagram of the multi-display processor subsystem 600 which includes the multi-display processor 224 and the RAM 230 and other connections 206, 214, 216 and 226 from FIG. 2. The representative units within the multi-display processor 224 include a frame comparer 602, a frame manager 604, a data encoder 606, and system controller 608. These functional units are representative of the processing steps performed and could be performed by a multi-purpose programmable solution, a DSP or some other type of processing hardware.

Though the preferred embodiment is for multiple displays, for the sake of clarity, this disclosure will first describe a system with a single remote display screen 310. For this sample remote display, the remote display system 300, the graphics and video display controller 212 and the multi-display processor 224 are all configured to support a common display format typically defined as a color depth and resolution. Configuration is performed by a combination of existing and enhanced protocols and standards including digital display control (DDC), and Universal Plug and Play (uPNP), and utilizing the multi-display support within the Windows or Linux operating systems, and may be enhanced by having a management setup and control system application.

The graphics and video display controller 212 provides the initial display data frame over SDVO1 214 to the multi-display processor 224 where the frame manager 604 stores the data over path 610 into memory 230. Frame manager 604 keeps track of the display and storage format information for the frames of display data. When the subsequent frames of display data are provided over SDVO1 214, the frame comparer 602 comparers the subsequent frame data to the just prior frame data already stored in RAM 230. The prior frame data is read from RAM over path 610. The new frame of data may either be compared as it comes into the system on path 214, or may be first stored to memory by the frame manager 604 and then read by the frame comparer 602. Performing the comparison as the data comes in saves the memory bandwidth of an additional write and read to memory and may be preferred for systems where memory bandwidth is an issue. This real time processing is referred to as “on the fly” and may be a preferred solution for reduced latency.

The frame compare step identifies which pixels and regions of pixels have been modified from one frame to the next. Though the comparison of the frames is performed on a pixel-by-pixel basis, the tracking of the changes from one frame to the next is typically performed at a higher granularity. This higher granularity makes the management of the frame differences more efficient. In one embodiment, a fixed grid of 128×128 pixels, referred to as a precinct, may be used for tracking changes from one frame to the next. In other systems the precinct size may be larger or smaller and instead of square precincts, the tracking can also be done on the basis of a rectangular region, scan line or a group of scan lines. The block granularity used for compression may be a different size than the precinct and they are somewhat independent though the minimum precinct size would not likely be smaller than the block size.

The frame manager 604 tracks and records which precincts or groups of scan lines of the incoming frame contain new information and stores the new frame information in RAM 230, where it may replace the prior frame information and as such will become the new version of prior frame information. Thus, each new frame of information is compared with the prior frame information by frame comparer 602. The frame manager also indicates to the data encoder 606 and to the system controller 608 when there is new data in some of the precincts and which ones those precincts are. From an implementation detail, the new data may be double-buffered to assure that data encoder 606 accesses are consistent and predictable. In another embodiment where frames are compared on the fly, the data encoder may also compress data on the fly. This is particularly useful for scan line and multi-scan line based data compression.

For block based data encoding the data encoder 606 accesses the modified precincts of data from RAM 230 and compresses the data. System controller 608 keeps track of the display position of the precincts of encoded data and manages the data encoding such that a display update stream of information can be provided via the main system bus 206 or path 226 to the network controller. Because the precincts may not align to any particular display surface, in the preferred embodiment any precinct can be independently encoded without concern for creating visual artifacts between precincts or on the edges of the precincts. However, depending on the type of data encoding used, the data encoder 606 may require accessing data beyond the changed precincts in order to perform the encoding steps. Therefore, in order to perform the processing steps of data encoding, the data encoder 606 may access data beyond just the precincts that have changed. Lossless encoding systems should never have a problem with precinct edges. Another type of data encoding can encode blocks that are smaller than the full precinct, though the data from the rest of the precinct may be used in the encoding for the smaller block.

A further enhanced system does not need to store the prior frame in order to compare on-the-fly. An example is a system that includes eight line buffers for the incoming data and contains storage for a checksum associated with each eight lines of the display from the prior frame. A checksum is a calculated number that is generated through some hashing of a group of data. While the original data can not be reconstructed from the checksum, the same input data will always generate the same checksum, whereas any change to the input data will generate a different checksum. Using 20 bits for a checksum gives two raised to the twentieth power, or about one million, different checksum possibilities. This means there would be about a one in a million chance of an incorrect match. The number of bits for the checksum can be extended further if so desired.

In this further enhanced system, each scan line is encoded on the fly using the prior seven incoming scan lines and the data along the scan line as required by the encoding algorithm. As each group of eight scan lines is received, the checksum for that group is generated and compared to the checksum of those same eight lines from the prior frame. If the checksum of the new group of eight scan lines matches the checksum of the prior frame's group of eight scan lines, then it can be safely assumed that there has been no change in display data for that group of scan lines, and the system controller 608 can effectively abort the encoding and generation and transmission of the display update stream for that group of scan lines. If after receiving the eight scan lines, the checksums for the current frame and the prior frame are different, then that block of scan lines contains new display data and system controller 608 will encode the data and generate the display update stream information for use by the network controller 228 in providing data for the new frame of a remote display. In order to improve the latency, the encoding and check sum generation and comparison may be partially overlapped or done in parallel. The data encoding scheme for the group of scan lines can be further broken into sub blocks of the scan lines and the entire frame may be treated as a single precinct while the encoding is performed on just the necessary sub blocks.

A group of scan lines can also be used to perform block based encoding where the vertical size of the block fits within the number of scan lines used. For example, if the system used a block based encoding where the block size were 16×16, as long as 16 scan lines were stored at a time, the system could perform block based encoding. For MPEG which is block based, such a system implementation could be used to support a I-Frame only block based encoding scheme. The advantage would be that the latency for such a system would be significantly less than a system that requires either the full frame or multiple frames in order to perform compression.

When the prior frame data is not used in the encoding, the encoding step uses one of any number of existing or enhanced versions of known lossy or lossless two dimensional compression algorithms, including but not limited to Run Length Encoding (RLE), Wavelet Transforms, Discrete Cosign Transform (DCT), MPEG I-Frame, vector quantization (VQ) and Huffman Encoding. Different types of content benefit to different extents based on the encoding scheme chosen. For example, frames of video images contain varying colors but not a lot of sharp edges, which is fine for DCT based encoding schemes, whereas text includes a lot of white space between color changes, but has very sharp edge transitions that need to be maintained for accurate representation of the original image where DCT would not be the most efficient encoding scheme. The amount of compression required will also vary based on various system conditions such as the network bandwidth available and the resolution of the display. For systems that are using a legacy device as a remote display system controller, such as an HDTV or an HD DVD player, the encoding scheme must match the decoding capabilities of the remote display system.

For systems that include the prior frame data as part of the encoding process, more sophisticated three dimensional compression techniques can be used where the third dimension is the time domain of multiple frames. Such enhancements for time processing include various block matching and block motion techniques which can differ in the matching criteria, search organization and block size determination.

While the discussion of FIG. 6 primarily described the method for encoding data for a single display, FIG. 6 also indicates a second display input path SDVO2 216 that can perform similar processing steps for a second display input from a graphics and video display controller 212, or from a second graphics and display controller (not shown). Advanced graphics and display controllers 212 are designed with dual SDVO outputs in order to support dual displays for a single user or to support very high resolution displays where a single SDVO port is not fast enough to handle the necessary data rate. The processing elements of the multi-display processor including the frame comparer 602, the frame manager 604, the data encoder 606 and the system controller 608 can either be shared between the dual SDVO inputs, or a second set of the needed processing units can be included. If the processing is performed by a programmable DSP or Media Processor, either a second processor can be included or the one processor can be time multiplexed to manage both inputs.

The multi-display processor 224 outputs a display update stream to the FIG. 2 network controller 228 which in turn produces a display update network stream at one or more network interfaces 290. The networks may be of similar or dissimilar nature but through the combination of networks, each of the remote display systems 300-308 is accessible. High speed networks such as Gigabit Ethernet are preferred but are not always practical. Lower speed networks such as 10/100 Ethernet, Power Line Ethernet, coaxial cable based Ethernet, phone line based Ethernet or wireless Ethernet standards such as 802.11a, b, g, n, s and future derivatives can also be supported. Other non-Ethernet connections are also possible and can include USB, 1394a, 1394b, 1394c or other wireless protocols such as Ultra Wide Band (UWB) or WiMAX.

The various supported networks can support a variety of transmission schemes. For example, Ethernet typically supports protocols such as standard Transport Control Protocol and Internet Protocol (TCP/IP), UDP or some form of lightweight handshaking in combination with UDP transmissions. The performance of the network connection will be one of the critical factors in determining what resolution, color depth and frame rate can be supported for each remote display system 300-308. Forward Error Correction (FEC) techniques can be used along with managing UDP and TCP/IP packets to optimize the network traffic to assure critical packets get through on the first attempt and non-critical packets will not get retransmitted, even if they are not successfully transmitted on the first try.

The remote display performance can be optimized by matching the network performance and the display encoding dynamically in real time. For example, if the network congestion on one of the connections for one of the remote display systems increases at a point in time, the multi-display processor can be configured dynamically to reduce the data created for that remote display. When such a reduction becomes necessary, the multi-display processor can reduce the display stream update data in various ways with the goal of having the least offensive effect on the quality of the display at the remote display system. Typically, the easiest adjustment is to lower the frame rate of display updates.

It is not typically possible or desirable to dynamically adjust the set-up of display resolution mode or display color depth mode of the remote display system as it would require a reconfiguration of the display and the user would clearly find such as adjustment offensive. However, depending on the data encoding method used, the effective resolution and effective color depth within the existing display format can be adjusted without the need to reconfigure the display device and with a graceful degradation of the display quality.

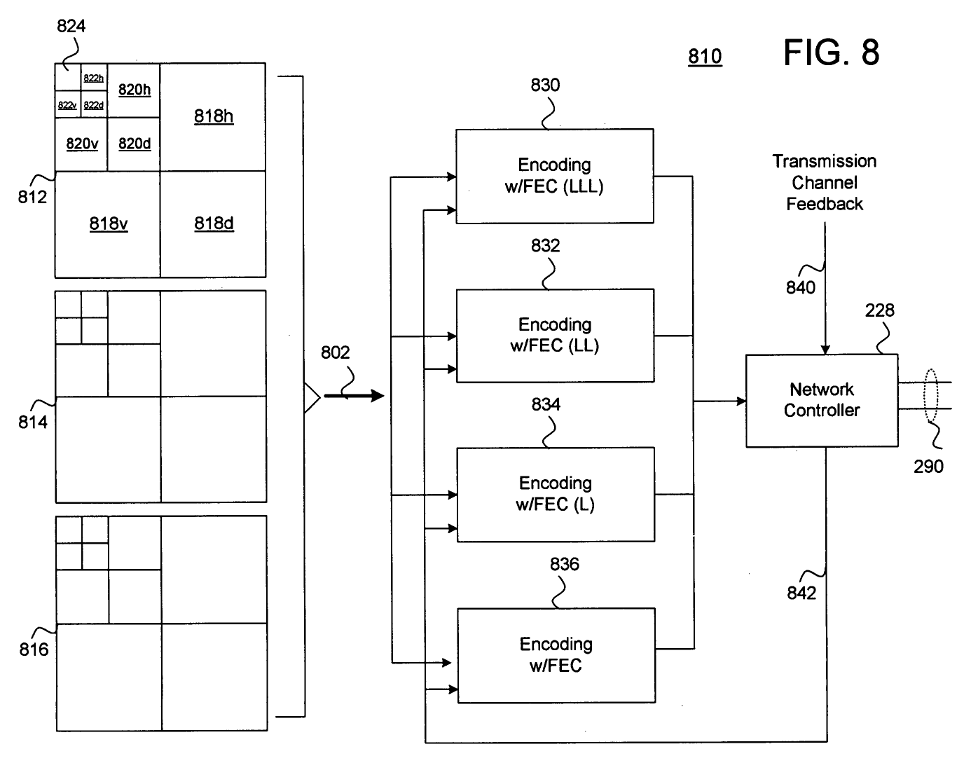

Graceful degradation of this kind takes advantage of some of the characteristics of the human visual system's psycho visual acuity where, when there some more changes and motion in the display, the psycho visional acuity is less sensitive to the sharpness of the picture. For example, when a person scrolls through a text document, his eye cannot focus on the text as well as when the text is still, so that if the text blurred slightly during scrolling, it would not be particularly offensive. Since the times of the most display stream updates correspond to the added motion on the display, it is at those times it may be necessary to reduce the sharpness of the transmitted data in order to lower the data rate. Such a dynamic reduction in sharpness can be accomplished with a variety of encoding methods, but is particularly well suited for Wavelet Transform based compression where the image is subband coded into different filtered and scaled versions of the original image. This will be discussed in further detail with respect to FIG. 8.

Multi-display processor 224 will detect when a frame input over the SDVO bus intended for a remote display system is unchanged from the prior frame for that same remote display system. When such a sequence of unchanged frames is detected by the frame comparer 602, the data encoder 606 does not need to perform any encoding for that frame, the network controller 228 will not generate a display update network stream for that frame, and the network bandwidth is conserved as the data necessary for displaying that frame already resides in the RAM 312 at the remote display system 300. Similarly, no encoding is performed and no network transmission is performed for identified precincts or groups of scan lines that the frame manager 604 and frame comparer 602 are able to identify as unchanged. However, in each of these cases, the data was sent over the SDVO bus and may have been stored and read from RAM 230.

These SDVO transmissions and RAM movements would not be necessary if the host system 200 were able to track which display frames are being updated. Depending on the operating system it is possible for the CPU subsystem 202 to track which frames for which displays are being updated. There are a variety of software based remote display Virtual Network Computing (VNC) products which use software to reproduce the look of the display of a computer and can support viewing from a different type of platform and over low bandwidth connections. While conceptually interesting, this approach does not mimic a real time response or support multi-media operations such as video and 3D that can be supported by this preferred embodiment. However, a preferred embodiment of this invention can use software, combined with the multi-display processor hardware, to enhance the overall system capabilities.

Various versions of Microsoft Windows operating systems use Graphics Device Interface (GDI) calls for operations to the graphics and video display controller 212. Similarly, there are Direct Draw calls for controlling the primary and secondary surface functions, Direct 3D calls for controlling the 3D functions, and Direct Show calls for controlling the video playback related functions. For Microsoft's DX10, there is an additional requirement to support block transfers from the YUV color space to the RBG color space and all of the video and 2D processing can be performed within the 3D shader pipeline. Providing a tracking software layer that either intercepts the various calls, or utilizing other utilities within the display driver architecture, can enable the CPU subsystem 202 to track which frames of which remote display system are being updated. By performing this tracking, the CPU can reduce the need to send unchanged frames over the SDVO bus. It would be further advantageous if the operating system or device driver support provided more direct support for tracking which displays, which frames and which precincts within the frame had been modified. This operating system or device driver information could be used in a manner similar to the method described for the tracking software layer. The software interface relating to controlling video decoding, such as Direct Show in Windows XP, can be used as the interface for forwarding an encoded video stream for decoding at the remote display system.

In a preferred embodiment, the CPU subsystem 202 can process data for more remote display systems than the display control portion of the graphics and video display controller 212 is configured to support at any one time. For example, in the tiled display configuration for twelve simultaneous remote display systems of FIG. 4, additional displays could be swapped in and out of place of displays one through twelve based on the tracking software layer. If the tracking software detected that no new activity had occurred for display 5, and that a waiting list display 13 (not shown) had new activity, then CPU subsystem 202 would swap out display 13 in the place of display 5 in the tiled display memory area. CPU subsystem 202 may use the 2D processor of the 2D, 3D and video graphics processors 410 to perform the swapping. A waiting list display 14 (not shown) could also replace another display such that the twelve shown displays are essentially display positions in and out of which the CPU subsystem 202 can swap an arbitrary number of displays. The twelve position illustration is arbitrary and the system 100 could use as few as one and as many positions as the mapping of the display sizes allows. There are several considerations for using a tracking software layer for such a time multiplexing scheme. The display refresh operation of display controller 404 is asynchronous to the drawing by the 2D/3D and video processors 410 as well as asynchronous to the CPU subsystem 202 processes. This asynchronous operation makes it difficult for the multi-display processor 224 to determine from the SDVO data if a display in the tiled display memory is the pre-swap display or the post-swap display. Worse, if the swap occurred during the read out of the tiled display region being swapped, it would be possible for corrupted data to be output over SDVO. Synchronizing the swapping with the multi-display processor 224 will require some form of semaphore operation, atomic operation, time coordinated operation or software synchronization sequence.

The general software synchronization sequence informs the multi-display processor 224 that the display in (to use the example above) position 5 is about to be swapped and to not use the data from that position. The multi-display processor could still utilize data from any of the other tiled display positions that were not being swapped. The CPU subsystem 202 and graphics and video processor 410 will update the tiled display position with the new information for the swapped display. CPU subsystem 202 then informs the multi-display processor that data during the next SDVO tiled display transfer would be from the new swapped display and can be processed for the remote display system associated with the new data. Numerous other methods of synchronization, including resetting display controller 404 to utilize another area of memory for the display operations, are possible to achieve swapping benefits of supporting more users than there are hardware display channels at any one time.

As described, it is possible to support more remote display systems 300-308 than there are positions in the tiled display 406. Synchronization operations will take away some of the potential bandwidth for display updates, but overall, the system will be able to support more displays. In particular, a system 100 could have many remote displays with little or no activity. In another system, where many of the remote displays do require frequent updates, the performance for each remote display would be gracefully degraded through a combination of reduced frame rate and reducing the visual detail of the content within the display. If the system only included one display controller 404, the group of six displays, 1 through 6, could be reconfigured such that the display controller would utilize the display memory associated with the group of six displays 7 through 12 for a time, then be switched back.

The tiled method typically uses the graphics and video display controller 212 to provide the complete frame information for each tile to the multi-display processor 224. There is also the ability to provide sub frame information via this tile approach provided that the sub frame information relating to the position information of the subframe is also provided. In a sub-framed method, instead of a complete frame occupying the tile, a number of sub-frames that can fit in that same area, are fit into the same area. Those sub-frames can all relate to one frame or relate to multiple frames.

Another method to increase the number of remote displays supported is to bank switch the entire tile display area. For example, tiles corresponding to displays 1 through 6 may be refreshed over the SDVO1 214 output while tiles corresponding to displays 7 through 12 are being drawn and updated. At the appropriate time, a bank switch occurs and the tiles for displays 7 through 12 become the active displays and tiles for displays 1 through 6 are then redrawn where needed. By performing the bank switching all of the tiles at once, the number of synchronization steps may be less than if each display was switched independently.

To recap, by configuring and combining at a system level, the graphics and video display controller 212 with a multi-display processor 224 is able to support configurations varying in the number of remote display systems, resolution and color depth for each display, and the frame rate achievable by each display. An improved configuration could include four or more SDVO output ports, and combined with the swapping procedure, could increase the ability of the system to support even more remote display systems at higher resolutions. However, increasing the overall SDVO bandwidth and using dedicated memory and swapping for the multi-display processor comes at an expense in both increased system cost and potentially increased system latency.

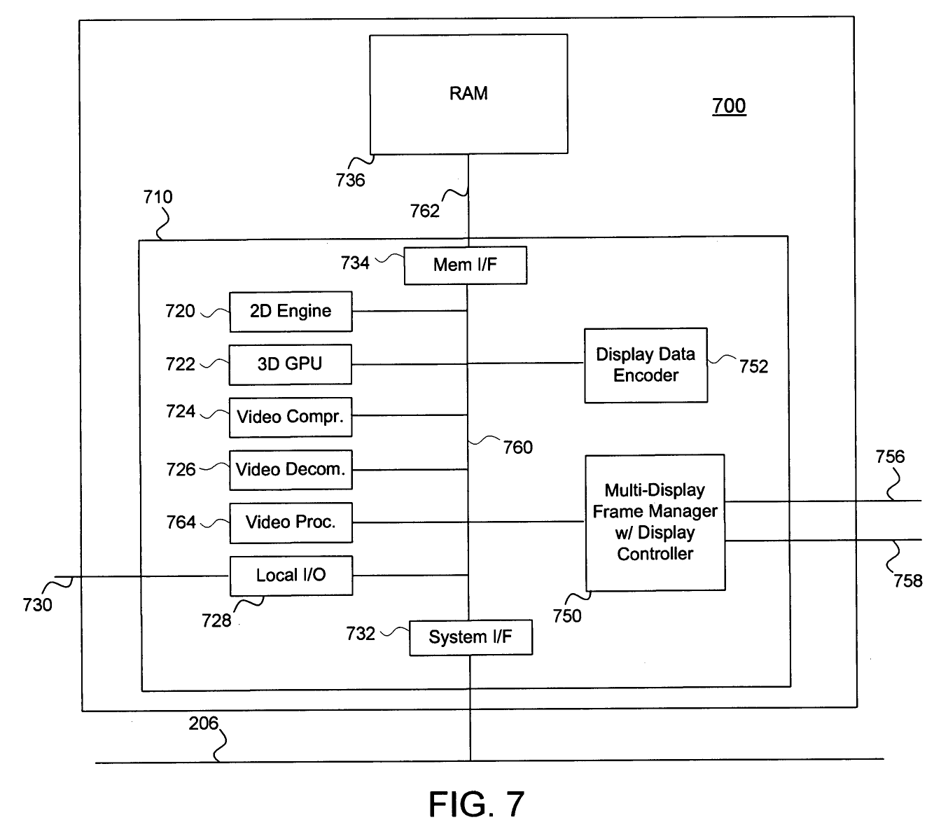

In an enhanced embodiment, not appropriate for all systems, it is desirable to combine the multi-display processor with the system's graphics and video controller and share a common memory subsystem. FIG. 7 shows a preferred System-On-Chip (SOC) integrated circuit embodiment of a graphics and video multi-display system 700 that combines multi-user display capabilities with capabilities of a conventional graphics controller having a display controller that supports local display outputs. SOC 700 would also connect to main system bus 206 in the host system 200 of a multi-display system 100 (FIG. 1).

In a preferred embodiment, the integrated SOC graphics and video multidisplay system 700 includes a 2D Engine 720, a 3D Graphics Processing Unit (GPU) 722, a system interface 732 such as PCI express, control for local I/O 728 that can include interfaces 730 for video or other local I/O, such as a direct interface to a network controller, and a memory interface 734. Additionally, system 700 may include some combination of video compressor 724 and video decompressor 726 hardware, or some form of programmable video processor 764 that combines those and other video related functions. In some systems a 3D GPU 722 will have the necessary programmability in order to perform some or all of the video processing which may include the compression, decompression or data encoding.

While an embodiment can utilize the software driven GPU and Video Processor approach for multi-display support as described above, the performance of the system as measured by the frame rates for the number of remote displays will be highest when using a graphics controller that includes a display subsystem optimized for multi-display processing. This further preferred embodiment (FIG. 7) includes a multi-display frame manager with display controller 750 and a display data encoder 752 that compresses the display data. The multi-display frame manager with display controller 750 may include outputs 756 and 758 for local displays, though the remote multi-display aspects are supported over the system interface 732 or potentially a direct connection 730 to a network controller such as 228. The system bus 760 is illustrative of the connections between the various processing portions or units as well as the system interface 732 and memory interface 734. The system bus 760 may include various forms of arbitrated transfers and may also have direct paths from one unit to another for enhanced performance.

The multi-display frame manager with display controller 750 supports functions similar to the FIG. 6 frame manager 604 and frame comparer 602 of multi-display processor 224. By way of being integrated with the graphics subsystem, some of the specific implementation capabilities improve, though the previously described functions of managing the multiple display frames in memory, determining which frames have been modified by the CPU, running various graphics processors and video processors, and managing the frames or blocks within the frames to be processed by the display data encoder 752 are generally supported.

In the FIG. 2 multi-chip approach of host system 200, the graphics and video display controller 212 is connected via the SDVO paths to the multi-display processor 224, and each controller and processor has its own RAM system. In contrast, the FIG. 7 graphics and video multi-display system 700 uses the shared RAM 736 instead of the SDVO paths. Using RAM 736 eliminates or reduces several bottlenecks. First, the SDVO path transfer bandwidth issue is eliminated. Second, by sharing the memory, the multi-display frame manager with display controller 750 is able to read the frame information directly from the memory thus eliminating the read of memory by a graphics and video display controller 212. For systems where the multi-display processor 224 was not performing operations on the fly, a write of the data into RAM is also eliminated.

Host system 200 allows use of a graphics and video display controller 212 that may have not been designed for a multi-display system. Since the functional units within the graphics and video multi-display system 700 may all be designed to be multi-display aware, additional optimizations can also be implemented. In a preferred embodiment, instead of implementing the multi-display frame support with a tiled display frame architecture, the multi-display frame manager with display controller 750 may be designed to map support for multiple displays that are matched as far as resolution and color depth in their corresponding remote display systems.

By more directly matching the display in memory with the corresponding remote display systems, the swapping scheme described above can be much more efficiently implemented. Similarly, the tracking software layer described earlier could be assisted with hardware that tracks when any pixels are changed in the display memory area corresponding to each of the displays. However, because a single display may include multiple surfaces in different physical areas of memory, a memory controller-based hardware tracking scheme may not be the most economical choice.

The tracking software layer can also be used to assist in the encoding choice for display frames that have changed and require generation of a display update stream. As mentioned above, encoding reduces the amount of data required for the remote display system 300 to regenerate the display data generated by the host system's graphics and video display controller 212. The tracking software layer can help identify the type of data within a surface where display controller 404 translates the surface into a portion of the display frame. That portion of the display frame, whether precinct based or scan line based encoding is used, can be identified to data encoder 606, or display data encoder 752, as to allow the most optimal type of encoding to be performed.

For example, if the tracking software layer identifies that a surface is real time video, then an encoding scheme more effective for video, which has smooth spatial transitions and temporal locality, can be used for those areas of the frame. If the tracking software layer identifies that a surface is mostly text, then an encoding scheme more effective for the sharp edges and the ample white space of text can be used. Identifying what type of data is in what region is a complicated problem. However, this embodiment of a tracking software layer allows an interface into the graphics driver architecture of the host display system and host operating system that assists in this identification. For example, in Microsoft Windows, a surface that utilizes certain DirectShow commands is likely to be video data whereas a surface that uses color expanding bit block transfers (Bit Blits) normally associated with text, is likely to be text. Each operating system and graphics driver architecture will have its own characteristic indicators. Other implementations can perform multiple types of data encoding in parallel and then choose to use the encoding scheme that produces the best results based on encoder feedback.

In the case where the tracking software layer also tracks the encoded video program data prior to it being decoded as a surface in the host system, the tracking software layer identifies that the encoded video program data is in an encoded video format that the target remote display system can decode. When such a case is identified, rather than the video being decoded on host system 200, only to be re-encoded, the original encoded video source may be transmitted to the target remote display system for decoding. This allows for less processing on the host system and eliminates any chance of video quality degradation. The only limitation is that the host can not perform any of the keying or overlay features on the video stream.

Some types of encoding schemes are particularly more useful for specific types of data, and some encoding schemes are less susceptible to the type of data. For example, RLE is very good for text and very poor for video, DCT based schemes are very good for video and very poor for text, and wavelet transform based schemes can do a good job for both video and text. Though any type of lossless or lossy encoding can be used in this system, wavelet transform encoding, which also can be of a lossless or lossy type, for this application will be described in some detail. While optimizing the encoding based on the precinct is desirable, it can not be used where it will cause visual artifacts at the precinct boundaries or create other visual problems.

FIG. 8 illustrates the process of decomposing a frame of video into subbands prior to processing for optimal network transmission. The first step is for each component of the video to be decomposed via subband encoding into a multi-resolution representation. The quad-tree-type decomposition for the luminance component Y is shown in 812, for the first chrominance component U in 814 and for the second chrominance component V in 816. The quad-tree-type decomposition splits each component into four subbands where the first subband is represented by 818(h) 818(d) and 818(v) with the h, d and v denoting horizontal, diagonal and vertical. The second subband, which is one half the first subband resolution in both the horizontal and vertical direction, is represented in 820(h), 820(d) and 820(v). The third subband is represented by 822(h), 822(d) and 822(v) and the fourth subband by box 824. Forward Error Correction (FEC) is an example of a method for improving the error resilience of a transmitted bitstream. FEC includes the process of adding additional redundant bits of information to the base bits such that if some of the bits are lost or corrupted, the decoder system can reconstruct that packet of bits without requiring retransmission. The more bits of redundant information that are added during the FEC step, the more strongly protected, and the more resilient to transmission errors the bit stream will be. In the case of the wavelet encoded video, the lowest resolution subbands of the video frame may have the most image energy and can be protected via more FEC redundancy bits than the higher resolution subbands of the frame. Note that the higher resolution subbands are typically transmitted with only the added resolution of the high band and does not include the base information from the lower bands.

Instead of just adding bits during an FEC processing step, a more sophisticated processing step can provide error resiliency bits while performing the video encoding operation. This has been referred to as the “source based encoding” method and is superior to generating FEC bits after the video has already been encoded. The general problem of standard FEC is that it pays a penalty of added bits all of the time for all of the packets. Instead, a dynamic source based encoding scheme can add the error resilience bits only when they are needed based on real time feedback of transmission error rates. Additionally, there are other coding techniques which spread the encoded video information across multiple packets such that when a packet is not recoverable due to transmission errors, the video can be more readily reconstructed by the packets that are successfully received and errors can more effectively be concealed. These advanced techniques are particularly useful for wireless networks where the packet transmission success rates are lower and can vary more. Of course in some systems requesting a retransmission of a non-recoverable packet is not a problem and can be accomplished without adversely affecting the system.

In a typical network system, the FEC bits are used to protect a complete packet of information where each packet is protected by a checksum. When the checksum properly arrives at the receiving end of a network transmission, the packet of information can be assumed to be correct and the packet is used. When the checksum arrives improperly, the packet is assumed to be corrupted and is not used. For packets of critical information that are corrupted, the network protocol may re-transmit them. For video, retransmission should be avoided as by the time a retransmitted packet is sent, it may be too late to be of use. The retransmission can make a bad situation of corrupted packets worse by adding the associated data traffic of retransmission. It is therefore desirable to assure that the more important packets are more likely to arrive uncorrupted and for less important packets, even if they are corrupted, to design the system not to retransmit the less important packets. The retransmission characteristics of a network can be managed in a variety of ways including selection of TCP/IP and UDP style transmissions along with other network handshake operations. Transport protocols such as RTP, RTSP and RTCP can be used to enhance packet transfers and can be further enhanced by adding re-transmit protocols.

The different subbands for each component are passed via path 802 to the encoding step. The encoding step is performed for each subband with the encoding with FEC performed on the first subband 836, on the second subband 834, on the third subband 832 and on the fourth subband 830. Depending on the type of encoding performed, there are various other steps applied to the data prior to or as part of the encoding process. These steps can include filtering or differencing between the subbands. Encoding the differences between the subbands is one of the steps of a type of compression. For typical images, most of the image energy resides in the lower resolution representations of the image. The other bands contain higher frequency detail that is used to enhance the quality of the image. The encoding steps for each of the subbands uses a method and bitrate most suitable for the amount of visual detail contained in that subimage.

There are also other scalable coding techniques that can used to transmit the different image subbands across different communication channels having different transmission characteristics. This technique can be used to match the higher priority source subbands with the higher quality transmission channels. This source based coding can be used where the base video layer is transmitted in a heavily protected manner and the upper layers are protected less or not at all. This can lead to good overall performance for error concealment and will allow for graceful degradation of the image quality. Another technique of Error Resilient Entropy Coding (EREC) can also be used for high resilience to transmission errors.

In addition to the dependence on the subimage visual detail, the type of encoding and the strength of the error resilience is dependent on the transmission channel error characteristics. The transmission channel feedback 840 is fed to the Network Controller 228 which then feeds back the information via path 226 or over the system bus 206 to the multi-display processor (600 or 740) which controls each of the subband encoding blocks. Each of the subband encoders transmits the encoded subimage information to the communications processor 844. The Network Controller 228 then transmits the compressed streams via one of the network paths 290 to the target transmission subsystem.

As an extension to the described 2-D subband coding, 3-D subband coding can also be used. For 3-D subband coding, the subsampled component video signals are decomposed into video components ranging from low spatial and temporal resolution components to components with higher frequency details. These components are encoded independently using the method appropriate for preserving the image energy contained in the component. The compression is also performed independently through quantizing the various components and entropy coding of the quantized values. The decoding step is able to reconstruct the appropriate video image by recovering and combining the various image components. A properly designed system, through the encoding and decoding of the video, preserves the psychovisual properties of the video image. Block matching and block motion schemes can be used for motion tracking where the block sizes may be smaller than the precinct size. Other advanced methods such as applying more sophisticated motion coding techniques, image synthesis, or object-based coding are also possible.

Additional optimizations with respect to the transmission protocol are also possible. For example, in one type of system there can be packets that are retransmitted if errors occur and there can be packets that are not retransmitted regardless of errors. There are also various packet error rate thresholds that can be set to determine if packets need to be resent for different frames. By managing the FEC allocation, along with the packet transmission protocol with respect to the different subbands of the frame, the transmission process can be optimized to assure that the decoded video has the highest possible quality. Some types of transmission protocols have additional channel coding that may be managed independently or combined with the encoding steps.

System level optimizations that specifically combine the subband encoding with the UWB protocol are also possible. In one embodiment, the subband with the most image energy utilizes the higher priority hard reservation scheme of the Medium Access Control (MAC) protocol. Additionally, the low order band groups of the UWB spectrum that typically have higher ranges can be used for the higher image energy subbands. In this case, even if a portable TV was out of range of the UWB high order band groups, the receiver would still receive the UWB low order band groups and be able to display a moderate or low resolution representation of the original video. Source based encoding can also be applied for UWB transmissions as described earlier. Additionally, the convolution encoding and decoding that is part of the UWB FEC scheme can be further processed with respect to the source based coding.

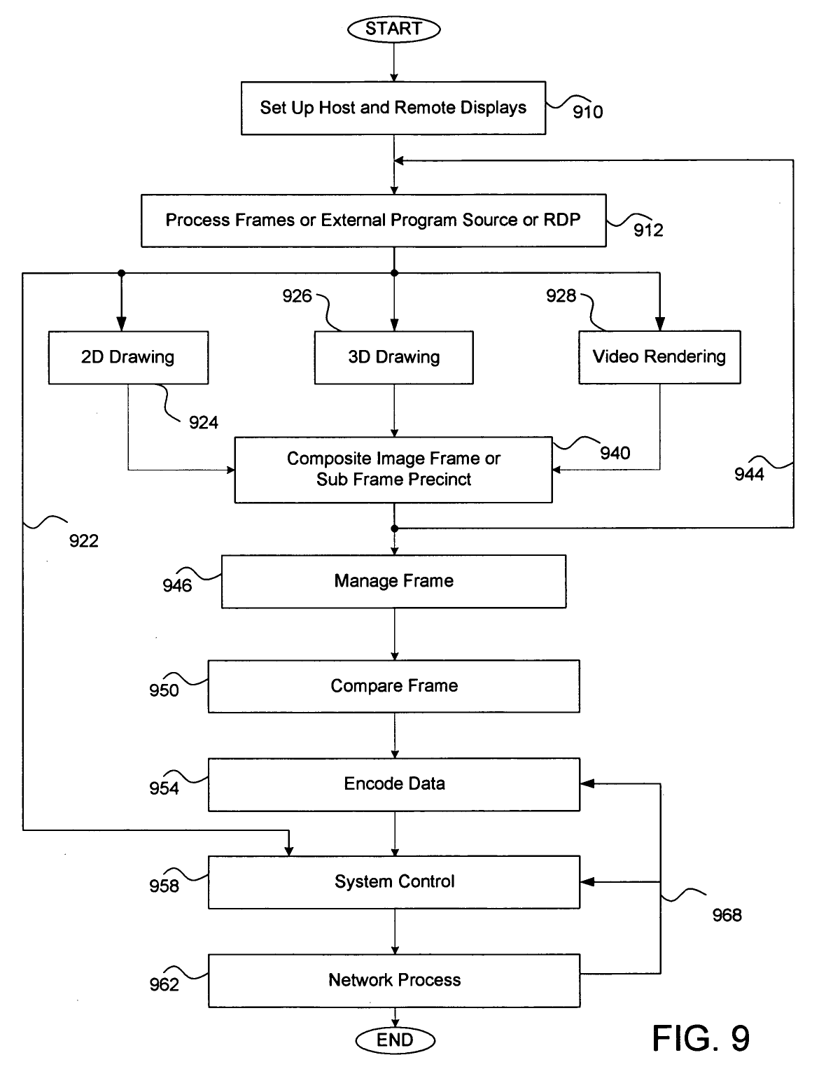

FIG. 9 is a flowchart of method steps for performing the multi-display processing procedure in accordance with one embodiment of the invention. For the sake of clarity, the procedure is discussed in reference to display data. However, procedures relating to audio and other data are equally contemplated for use in conjunction with the invention. In the FIG. 9 embodiment, initially, in step 910 Host system 200 and remote display systems 300-308 follow the various procedures to initialize and set up the host side and display side for the various subsystems to configure and enable each display. Additionally, during the setup each of the remote display systems informs the host system 200 what encoded data formats they are capable of decoding as well as what other display capabilities are supported.

In step 912, the host system CPU processes the various types of inputs to determine what operations need to be performed on the host and what operations will be transferred to the remote display system for processing remotely. This simplified flow chart does not specifically call for the input from the remote display systems 300-308 to be processed for determining the responsive graphics operations, though another method would include those steps. If the operation is to be performed on the host system, the graphics and video display controller 212 will perform the needed operations. If, however, the tracking software layer detects that an encoded video stream that can be decoded at the target remote display system is identified, and there isn't the need for the host system 200 to perform processing that requires decoding, the encoded video stream can bypass the intermediate processing steps and go directly to step 958 for system control. Similarly, if at this step, the operation is to be performed as a graphics operation at the remote display, the appropriate RDP call is formulated for transmission to the remote display system.

If host graphics operations include 2D drawing, then, in step 924, the 2D drawing engine 720 or associated function unit of graphics and video display processor 212 preferably processes the operations into the appropriate display surface in the appropriate RAM. Similarly, in step 926 3D drawing is performed to the appropriate display surface in RAM by either the 3D GPU 722 or the associated unit in graphics and video display processor 212. Similarly, in step 928, video rendering is performed to the appropriate display surface in RAM by one of the video processing units 724, 726 or the associated units in graphics and video display processor 212. Though not shown, any CPU subsystem 202-initiated drawing operations to the RAM would occur at this stage of the flow as well.

The system in step 940 composites the multiple surfaces into a single image frame which is suitable for display. This compositing can be performed with any combination of operations by the CPU subsystem 202, 2D engine 720, 3D GPU 722, video processing elements 724, 726 or 764, multi-display frame manager with display controller 750 or the comparable function blocks of graphics and video display controller 212. The 3D GPU 722 can perform video and graphics mixing, such as defined in the Direct Show Filter commands of Microsoft's Video Mixing Renderer (VMR) which is part of DirectX9. For Microsoft's DX10 there is an additional requirement to support block transfers from the YUV color space to the RBG color space and all of the video and 2D processing can be performed within the 3D shader pipeline. Once the compositing operation is performed, step 946 performs the frame management with the frame manager 604 or multi-display frame manager with display controller 750 which includes tracking the frame updates for each remote display. Then step 950 compares the frame to the previous frame for that same remote display system via a combination of the software tracking layer, combined with frame comparer 602 or the multi-display frame manager with display controller 750. The compare frame step 950 identifies which areas of each frame need to be updated for the remote displays where the areas can be identified by precincts, scan line groups or another manner.

The system, in step 954, then encodes the data that requires the update via a combination of software and data encoder 606 or display data encoder 752. The data encoding step 954 can use the tracking software to identify what type of data is going to be encoded so that the most efficient method of encoding is selected or the encoding hardware can adaptively perform the encoding without any knowledge of the data. In some systems the 3D GPU 722 will have the flexibility and programmability to perform the encoding step either alone or in conjunction with a video processor 764 or in conjunction with other dedicated hardware. Feedback path 968 from the network process step 962 may be used by the encode data step 954 in order to more efficiently encode the data to dynamically match the encoding to the characteristics of the network channel in a method of source based coding. This may include adjustments to the compression ratio as well as to the error resilience of the encoded data and, for subband encoded video, the different adjustments can operate on each subband separately. The error resilience and the method used to distribute the encoded data across the transmission packets may identify different priorities of data, based on subbands or based on other indicators, within the encoded data stream. The Real Time Control Protocol (RTCP) is one mechanism that can be used to feedback the network information including details and network statistics such as dropped packets, Signal-to-Noise Ratio (SNR) and delays.

The system, in step 958, utilizes the encoded data information from 954, possible RDP commands via path 922 or possible encoded video from external program sources via path 922, and the associated system information to manage the frame updates to the remote displays. The system control step 958 also utilizes the network transmission channel information via feedback path 968 to manage and select some of the higher level network decisions. This system control step is performed with some combination of the CPU subsystem 202 and system controller unit 608 or multi-display frame manager with display controller 750. In the cases where an encoded video stream was detected in step 912, the data stream is processed in this step 958 in order to prepare and manage the data stream prior to the network process step 962. The system control 958 may optimize the transmission by utilizing a combination of TCP/IP packets including RTSP, UDP packets including RTP for the content transmission. Additionally, UDP packets, including RTP packets which are typically not retransmitted, can be managed for selective retransmission using a handshake protocol that has less processing overhead than the standard TCP/IP handshake. For RDP commands, the system control in step 958 receives the drawing commands over path 922. Since the data bandwidth for these higher level commands is relatively low, and the importance of the commands is relatively high, the network packets for such RDP operations may be transmitted using TCP/IP or a retransmit protected version of a UDP protocol. Similarly, for encoded video streams from external program sources that are also provided via path 922, the system may not have managed the error resiliency as it would have for a processed encoded data or video stream. As such, there may be less ability to further optimize packet transmissions for the encoded video stream.

The host system 200, in performing system control step 958, may perform a bridge function for two or more disparate networks that have different characteristics. For example, the host system 200 may be connected over the Internet to a movie download service that will make sure that all of the bits of the movie get delivered to the subscriber. There may be a remote display system that is streaming the data over a local wireless network. The Internet connection and the local wireless network are very different and will have very different characteristics. If a packet does not properly transmit to the host system from the subscription service, the host system will simply request the packet be retransmitted. Typically, if a packet is lost over a wired connection through the Internet, it is due to some routing error somewhere in the chain and not because of some soft bit corruption error. Conversely, if a packet does not properly transmit from the host system to a wirelessly connected remote display system, it is likely due to some SNR issue with the wireless link, not a packet routing issue and the number of local hops is very low. In the case of the host acting as a streaming bridge between these two networks, the host can perform some advanced network bridging function either in conjunction with or independent from any video processing.

For example, the host system 200 may modify the network packets to enhance the source based FEC protocol. Other than just adding more redundancy bits the system can reorder the data and reallocate data packets across multiple packets from one network to the other. Other functions, such as combining or breaking up packets, translating between QoS mechanisms and changing the acknowledge protocols while operating as a bridge between networks is also possible. For example, the efficiency of one network may call for longer or shorter packet lengths than another, so the combining or breaking up of packets during the bridging enhances the overall system throughput. In another example, an Internet based transfer may use QoS at the TCP layer while a local network connection may perform QoS at the IP layer. In some bridge operations to outside networks, a full TCP/IP termination will need to occur in order to perform some of the network translation operations. In a system where the bridging is between two controlled networks, a full termination may not need to occur and a simpler translation on the fly can be performed.

In a system that uses RTP packets, additional enhancements to optimize network performance may be performed. Real time analysis of the network throughput of RTP packets can be observed and the sender of such packets can throttle the need for network bandwidth to allow for the most efficient network operation. A combination of RTCP and other handshaking on top of RTP packets can be used to observe the network throughput. The real time analysis can be further used as feedback to the source based encoding and to the packet generation of the network controller.

In another example, for streaming data from an Internet based server, the host system can act like a cache so that if the remote display system requests a retransmission of a packet, the host system can perform the retransmission without going all the way back through the Internet to request the packet be resent. In another system, if the source of the data is local, such as stored on a video server including a robust wired link, the host system can bridge the RTCP information of the wireless like to the remote display system all the way back to the video server so that the video data can be processed for packet transmission for the characteristics of the wireless link. This is done to avoid reprocessing the packets even though one of the network segments is robust enough that it would not typically use significant FEC. Similar bridging operations can occur between different wireless networks such as bridging an 802.11A network to a UWB network. Bridging between wired networks, such as a cable modem and a Gigabit Ethernet may also be supported.

The network process step 962 uses the information passed down through the entire process via the system control 958. This information can include information as to which remote display requires which frame update streams, what type of network transmission protocol is used for each frame update stream, and what the priority and retry characteristics are for each portion of each frame update stream. The network process step 962 utilizes the network controller 228 to manage any number of network connections 290. The various networks may include Gigabit Ethernet, 10/100 Ethernet, Power Line Ethernet, Coaxial cable based Ethernet, phone line based Ethernet, or wireless Ethernet standards such as 802.11a, b, g, n, s and future derivatives. Other non-Ethernet connections are also possible and can include USB, 1394a, 1394b, 1394c or other wireless protocols such as Ultra Wide Band (UWB) or WiMAX.

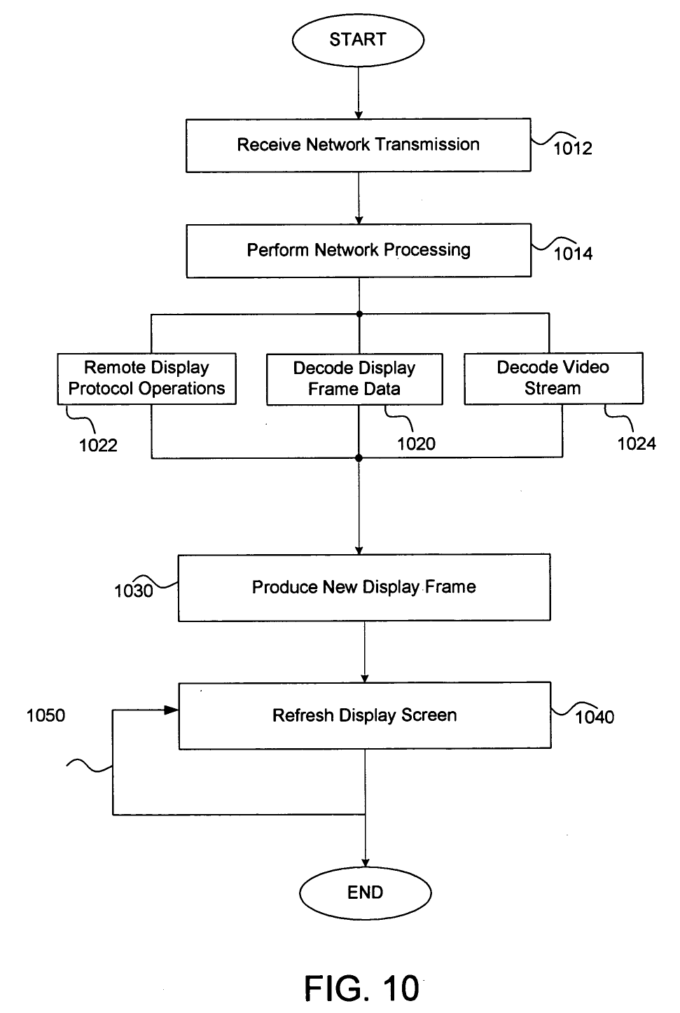

Additionally in steps 958 and 962, Network Controller 228 may be configured and may perform support of multiple network connections 290 that may be used together to further enhance the throughput from the host system 200 to the remote display systems. For example, two of the network connections 290 may both be Gigabit Ethernet where one of the Gigabit Ethernet channels is primarily used for transmitting UDP packets and the other Gigabit Ethernet channel is primarily used for managing the TCP/IP, Acknowledge packets and other receive, control and retransmit related packets that would otherwise slow down the efficient use of the first channel which is primarily transmitting large amounts of data. Other techniques of bonding channels, splitting channels, load balancing, bridging, link aggregation and a combination of these techniques can be used to enhance throughput. FIG. 10 is a flowchart of steps in a method for performing a network reception and display procedure in accordance with one embodiment of the invention. For reasons of clarity, the procedure is discussed in reference to display data. However, procedures relating to audio and other data are equally contemplated for use in conjunction with the present invention.

In the FIG. 10 embodiment, initially, in step 1012, remote display system 300 preferably receives a frame update stream from host system 200 of a multi-display system 100. Then, in step 1014, network controller 326 preferably performs a network processing procedure to execute the network protocols to receive the transmitted data whether the transmission was wired or wireless. Received data may include encoded frame display data, encoded video streams or Remote Display Protocol (RDP) commands.

In step 1020, data decoder and frame manager 328 receives and preferably manipulates the data information into an appropriate displayable format. In step 1030, data decoder and frame manager 328 preferably may access the data manipulated in step 1020 and produce an updated display frame into RAM 312. The updated display frame may include display frame data from prior frames, the manipulated and decoded new frame data, and any processing required for concealing display data errors that occurred during transmission of the new frame data. The data decoder and frame manager 328 is also able to decode and display various encoded data and video streams. The frame manager function determines if the encoded stream is decoded to full screen or to a window in of the screen. In the case where the remote display system includes a local graphics processor, such as in a Hybrid RDP system, additional combining and windowing of the remote graphics operations with stream decode and frame update streams may occur.

In step 1024, optional graphics and video controller 332 performs decode of a video display stream, typically decoding the video into external RAM 312. Similarly, in step 1022 the optional graphics and video controller 322 performs graphics operations to comply with a Remote Display Protocol. Again, the graphics operations are typically performed into external RAM 312. If the remote display system is running either an RDP protocol or a browser, the host system can encapsulate data packets into a form that the optional graphics and video controller 332 can readily process for display. For example, the host system could encapsulate the encoded data output from an application run on the host, like Word, Excel or PowerPoint, into a form such as encapsulated HTML such that the remote display system, though not typically able to run Word, Excel or PowerPoint, could display the program output on the display screen. In step 1030, a combination of the optional graphics and display controller 322, data decoder and frame manager 328 and CPU 324 prepare the received and processed data for the next step.

Finally, in step 1040, display controller 330 provides the most recent display frame data to remote display screen 310 for viewing by a user of the remote display system 300. For the Hybrid RDP systems, the display controller 330 may also perform an overlay operation for combining remote graphics, decoded video streams and decoded frame update streams. In the absence of either a screen saving or power down mode, the display processor will continue to update the remote display screen 310 with the most recently completed display frame, as indicated with feedback path 1050, in the process of display refresh.

The present invention therefore implements a flexible multi-display system that supports remote displays that a user may effectively utilize in a wide variety of applications. For example, a business may centralize computer systems in one location and provide users at remote locations with very simple and low cost remote display systems 300 on their desktops. Different remote locations may be supported over a LAN, WAN or through another connection. In another example, the host system may be a type of video server or multi-source video provider instead of a traditional computer system. Similarly designed systems can provide multi-display support for an airplane in-flight entertainment system or multi-display support for a hotel where each room has a remote display system capable of supporting both video and computer based content.

In addition, users may flexibly utilize the host system of a multi-display system 100 to achieve the same level of software compatibility and a similar level of performance that the host system could provide to a local user. Therefore, the present invention effectively implements a flexible multi-display system that utilizes various heterogeneous components to facilitate optimal system interoperability and functionality. Additionally, a remote display system may be a software implementation that runs on a standard personal computer where a user over the Internet may control and view any of the resources of the host system.

The invention has been explained above with reference to a preferred embodiment. Other embodiments will be apparent to those skilled in the art in light of this disclosure. For example, the present invention may readily be implemented using configurations other than those described in the preferred embodiment above. Additionally, the present invention may effectively be used in conjunction with systems other than the one described above as the preferred embodiment. Therefore, these and other variations upon the preferred embodiments are intended to be covered by the present invention, which is limited only by the appended claims.

I claim:

1. A graphics and video display controller capable of supporting multiple displays, comprising:
a display controller for supporting
a first number of local display devices via local display paths, and
a second number of remote display systems, not limited by the first number;
a 2D drawing engine for generating display frames which may each correspond to a display frame at a remote display system;
a video processor for processing one or more formats of video streams;
means for connecting to a CPU subsystem that explicitly tracks which of said display frames are modified so that only modified display frames will be transmitted via a network subsystem to remote display systems;
means for connecting to external program sources that provide video program data; and
means for connecting to a network controller which utilizes network paths to communicate with said remote display systems.

2. The system of claim 1 wherein said video processor encodes said modified display frames to reduce the network bandwidth of an encoded display stream output for said remote display systems.

3. The system of claim 1 wherein video content from said external program sources is processed by said host system and is transmitted over said network subsystem in an encoded format such that it can be decoded by one or more of said remote display systems.

4. A graphics and video multi-display system capable of supporting a first number of local display devices and an independent second number of remote display systems etc, comprising:
means to connect said graphics and video multi-display system to a CPU subsystem;
a graphics and video display controller capable of supporting a first number of local display devices by supplying display frames via a local display output path;
a multi-display processor that receives display frames from said local display output path, and that has
a frame manager and a frame comparer which process each received display frame, and
a data encoder which encodes frame data for transmission to update said remote display systems;
means to connect said graphics and video display system to external program sources which provide video program data; and
means to connect said graphics and video multi-display system to a network controller which in turn can be connected to said remote display systems.

5. The system of claim 4 wherein said graphics and video display controller is configured to composite multiple display planes of data prior to the frames being output on said local display paths, and wherein said multi-display processor processes said composite frames for multiple remote display systems.

6. The system of claim 4 wherein video program data from said external program sources can be processed by said multi-display processor to include source based encoding prior to transmission to said remote display systems.

7. A graphics and video multi-display system with integrated multiple display support, comprising:
a multi-display controller capable of supporting a large number of independent display frames tiled in memory;
a display data encoder capable of encoding display frame data;
means for connecting to a CPU subsystem; and
means for connecting to a network controller which in turn can be connected to a number of remote display systems.

8. The system of claim 7 wherein said graphics and video multi-display system composites surfaces into frames for each of said remote display systems, and further comprising a multi-display frame manager that implicitly tracks what display frame data is transmitted to each said remote display system, then responsively utilizes said display data encoder to encode the changed frames for transmission via said network controller.

9. The system of claim 7 wherein said multi-display system composites surfaces into frames for each of said remote display devices, tracks what display frame data is transmitted to each said remote display device, compares precincts of new frame data with preceding frame data and uses said display data encoder to encode changed precincts for transmission via said network controller.

10. The system of claim 7 wherein said host system transmits encoded video program data streams from said external program sources without changing the video encoding format.

11. A remote display system for use in a multi-display system, comprising:
a network controller for interfacing said remote display system to a host system in said multi-display system;
a data decoder and frame manager for decoding data received from said host system;
a local graphics and video controller including a local processor which runs a remote display protocol which performs graphics commands initiated by said host system;
and
a display controller for using the most recently reassembled frame of data to refresh a display screen; where said local processor manages functions of said remote display system.

12. The system of claim 11 wherein said local processor, said display controller, and said data decoder are implemented together as an integrated circuit.

13. The system of claim 11 wherein said data decoder includes a display data decoder and frame manager which support data resiliency based on source based encoding to conceal errors that occur in data transmission.

14. The system of claim 11 wherein said data decoder includes a video decoder for decoding video and providing said decoded video to said display controller for updating a display screen.

15. A host system for supporting multiple displays, comprising:
means to connect external program sources;
a CPU subsystem having a CPU which performs remote display procedures for controlling a graphics and video controller at a remote display system;
a local graphics and video processor for performing 2D, 3D and video processing functions;
a network subsystem providing a coupling through which said host system may be connected to multiple remote display systems; and
means to transmit an encoded bit stream for decoding at one or more of said remote display systems.

16. The system of claim 15 wherein said transmitted encoded bit stream includes compressed video data encoded in a compressed video format that can be decoded at said remote display system and where the encoding includes source based encoding techniques.

17. The system of claim 15 wherein said encoded bit stream is generated from the output from said local graphics processor that is encoded and transmitted via said network subsystem for decode at said remote display systems, and wherein said network subsystem performs UDP-based packet transmissions with a protocol for handshaking with retransmission capability.

18. A method for operating a multi-display system, comprising the steps of:
processing a set of graphics operations, using a host system and a graphics and video display controller, for drawing one or more display surfaces;
processing video program data from external program sources to translate said external program source video program data onto one or more display surfaces;
compositing the surfaces into display frames;
duplicating said drawing and compositing steps to generate display refresh stream frame data for each of multiple remote display systems;
encoding said display refresh stream frame data to produce an encoded display update network stream; and
propagating said encoded display update network stream according to network protocol techniques through a network interface.

19. The method of claim 18 wherein said compositing step utilizes a display controller capable of combining display surfaces with various overlay and keying techniques.

20. The method of claim 18 wherein said network protocol techniques utilize a UDP-based protocol that also includes handshaking and retransmit capability.

21. The method of claim 18 wherein said encoding step is performed by data encoding processing blocks based on source based encoding techniques.

22. A method for operating a multi-display system, comprising the steps of:
processing a set of graphics operations using a host system that includes a CPU, and translating said graphics operations to a remote display protocol for execution on a remote display system;
translating video program data received from external program sources into an encoded network stream; and
propagating said remote display protocol and said encoded network stream according to network protocol techniques through a network interface.

23. The method of claim 22, wherein said remote display system is capable of remote execution of said graphics operations and of decoding and displaying said encoded network streams of encoded video data.

24. The method of claim 22, wherein said remote display system is capable of remote execution of said graphics operations and of decoding and displaying said encoded network streams of encoded display frame data.

25. A method for receiving display updates from a host system and displaying video program data, comprising the steps of:
receiving, through a network subsystem from two or more data sources, display updates which may include remote display protocol graphics commands, encoded video bitstreams or encoded data display frames;
decoding said received encoded video bitstream and producing a new display frame of data for display; and
outputting said display frame of data to refresh a display screen and continuing to refresh said display screen with current display data until a new display frame of data becomes available.
